(19) United States
(12) Patent Application Publication
(10) Pub. No.: US 2025/0339810 A1
(43) Pub. Date: Nov. 6, 2025

(54) Integrated Ocean Alkalinity Enhancement And Seawater Desalination

(71) Applicant: Ebb Carbon, Inc., South San Francisco, CA (US)

(72) Inventors: Jeremy Loretz, Burlingame, CA (US); Todd Pelman, Moss Beach, CA (US)

(73) Assignee: Ebb Carbon, Inc., South San Francisco, CA (US)

(21) Appl. No.: 19/092,576

(22) Filed: Mar. 27, 2025

Related U.S. Application Data
(60) Provisional application No. 63/641,910, filed on May 2, 2024.
(60) Provisional application No. 63/716,029, filed on Nov. 4, 2024.

(51) Int. Cl. B01D 53/14; B01D 61/02; B01D 61/46; B01D 61/58; C02F 1/00; C02F 1/04; C02F 1/44; C02F 1/469; C02F 103/08

(52) U.S. Cl. CPC B01D 53/1493; B01D 53/1475; B01D 61/58; C02F 1/008; C02F 1/048; C02F 1/441; C02F 1/4693; B01D 61/025; B01D 61/46; B01D 2252/1035; B01D 2257/504; B01D 2258/06; C02F 2103/08

(57) ABSTRACT

A desalination unit processes saltwater feedstock (e.g., seawater) to generate freshwater (i.e., water suitable for human consumption, irrigation, or industrial uses) and a high-salt brine stream. An optional pretreatment unit removes contaminants from the saltwater feedstock before desalination. An electrochemical reactor converts the brine stream into a reduced-salt stream having a salt content lower than the saltwater feedstock by converting salt molecules contained in the brine stream into acid molecules contained in an acid product stream and base molecules contained in a base product stream. A mixing device combines the reduced-salt stream with the saltwater feedstock before the resulting mixture solution is delivered to the desalination unit for desalination. The base product stream leaving the electrochemical reactor may be used for ocean alkalinity enhancement (OAE), and the acid product stream may be used to reduce energy costs associated with crushing/grinding alkaline rock in an enhanced ocean weathering (EOW) process.

### RELATED APPLICATIONS/PATENTS

This application claims priority from U.S. Provisional Patent Application No. 63/716,029, entitled “Integrated Ocean Alkalinity Enhancement And Seawater Desalination”, filed on Nov. 4, 2024, which is entirely incorporated herein by reference.

This application also claims priority from U.S. Provisional Patent Application No. 63/641,910, entitled “Electrochemical Assisted Ocean Weathering”, filed on May 2, 2024, which is entirely incorporated herein by reference.

### FIELD OF THE INVENTION

The invention generally relates to desalination systems/methods that separate saltwater into freshwater and brine and to carbon dioxide removal systems/methods.

### BACKGROUND

As humans burn more and more fossil fuels, the resulting increased carbon dioxide (CO₂) concentration in Earth's atmosphere causes both climate change and ocean acidification. The increased atmospheric concentrations of CO₂ and other greenhouse gases (e.g., methane) produces climate change by trapping heat close to earth's surface, thereby increasing both air and sea temperatures. Because earth's oceans absorb about 25% of atmospheric CO₂, and because the absorbed CO₂ dissolves to form carbonic acid that remains trapped in the seawater, the increased atmospheric CO₂ concentration caused by burning fossil fuels also produces ocean acidification by way of increasing the amount of CO₂ gas dissolved in the ocean.

Both climate change and ocean acidification pose Climate change in the form significant threats to humans. of increased global average temperatures can produce several dangerous effects such as the loss of polar ice and corresponding increased sea levels, disease, wildfires and stronger storms and hurricanes. Ocean acidification changes the ocean chemistry that most marine organisms rely on. One concern with ocean acidification is that the decreased seawater pH can lead to the decreased survival of shellfish and other aquatic life having calcium carbonate shells, as well as some other physiological challenges for marine organisms.

To avoid dangerous climate change, the international Paris Agreement aims to limit the increase in global average temperature to no more than 1.5° C. to 2° C. above the temperatures of the pre-industrial era. Global average temperatures have already increased by between 0.8° C. and 1.2° C. The Intergovernmental Panel on Climate Change (IPCC) estimates that a ‘carbon budget’ of about 500 GtCO₂ (billion tons of carbon dioxide), which corresponds to about ten years at current emission rates, provides a 66% chance of limiting climate change to 1.5° C.

In addition to cutting CO₂ emissions by curtailing the use of fossil fuels, climate models predict that a significant deployment of Negative Emissions Technologies (NETs) will be needed to avoid catastrophic ocean acidification and global warming beyond 1.5° C. (see “Biophysical and economic limits to negative CO₂ emissions”, Smith P. et al., Nat. Clim. Chang. 2016; 6:42-50). Current atmospheric CO₂ and other greenhouse gas concentrations are already at dangerous levels, so even a drastic reduction in greenhouse gas emissions would merely curtail further increases, not reduce atmospheric greenhouse gas concentrations to safe levels. Moreover, the reduction or elimination of certain greenhouse gas sources (e.g., emissions from long-distance airliners) would be extremely disruptive and/or expensive and are therefore unlikely to occur soon.

Therefore, there is a need to supplement emission reductions with the deployment of NETs, which are systems/processes that serve to reduce existing atmospheric greenhouse gas concentrations by, for example, capturing/removing CO₂ from the air and sequestering it for at least 1,000 years. The need for NETs may be explained using a bathtub analogy in which atmospheric CO₂ is represented by water contained in a bathtub, ongoing CO₂ emissions are represented by water flowing into the tub, and NETs are represented by processes that control water outflow through the tub's drain. In this analogy, reduced CO₂ emission rates are represented by partially turning off the water inflow tap—the slower inflow rate provides more time before the tub fills, but the tub's water level will continue to rise and eventually overflow. Using this analogy, although reducing CO₂ emissions may slow the increase of greenhouse gas in the atmosphere, critical concentration levels will eventually be reached unless NETs are implemented that can offset the reduced CO₂ emission level (i.e., remove atmospheric CO₂ at the same rate it is being emitted). Moreover, because greenhouse gas concentrations are already at dangerous levels (i.e., the tub is already dangerously full), there is an urgent need for NETs that are capable of significantly reducing atmospheric CO₂ faster than it is being emitted to achieve safe atmospheric concentration levels (i.e., outflow from the tub's drain must be greater than the reduced inflow from the tap to reduce the tub's water to a safe level).

NETs can be broadly characterized as Direct Air Capture (DAC) approaches and Ocean Capture approaches. DAC approaches utilize natural (e.g., reforestation) and technology-based methods to extract CO₂ directly from the atmosphere. Ocean capture approaches utilize various natural and/or technological processes to remove CO₂ from the atmosphere and store it in the ocean as bicarbonate, a form of carbon storage that is stable for over 10,000 years.

Electrochemical ocean alkalinity enhancement (electrochemical OAE or EOAE) represents an especially promising ocean capture approach that both reduces atmospheric CO₂ and mitigates ocean acidification by generating an ocean alkalinity product (i.e., an aqueous alkaline solution containing a fully dissolved base substance) and supplying the ocean alkalinity product to ocean seawater at a designated outfall location. Electrochemical OAE systems typically generate the required base substance using an electrochemical reactor referred to as a bipolar electrodialysis device (BPED), which generally includes an electrodialysis (ED) apparatus and associated flow control devices configured to perform an electrochemical salt-conversion process that converts salt supplied in an aqueous salt feedstock solution (e.g., seawater) into the base substance and an acid substance. The base substance produced by the BPED is then incorporated into the ocean alkalinity (base) product that is then supplied to the ocean. As the base substance diffuses (disperses) into the surrounding seawater it serves to directly reverse ocean acidification (i.e., by utilizing the base substance in the ocean alkalinity product to increase the ocean seawater's alkalinity), and indirectly reduces atmospheric CO₂ (i.e., increasing the ocean seawater's alkalinity increases the ocean's ability to absorb/capture atmospheric CO₂). Moreover, because the generated base substance is fully dissolved in the ocean alkalinity product, the electrochemical OAE approach avoids problems associated with other OAE approaches (e.g., dissolution kinetics issues that are associated with conventional mineral OAE approaches).

Although electrochemical OAE approaches show great potential in mankind's efforts to combat global warming and ocean acidification, their widespread acceptance as a suitable NET may be predicated on the continued development of OAE system features that minimize cost per unit of captured/removed atmospheric CO₂ (LCOC). For economic reasons related to carbon offsets and trading, NETs having relatively low LCOC ratings are typically favored over NETs exhibiting relatively high LCOCs. When calculating a NET's LCOC rating, many factors are taken into consideration, including capital costs (e.g., construction and installation expenses), and ongoing operating costs (e. g., land, water, maintenance, and electrical power expenses). In the case of OAE systems, the amount of atmospheric carbon removed from the atmosphere over an ocean depends on the amount of base substance supplied to the ocean (i.e., by way of the ocean alkalinity product), whereby the LCOC of an OAE system is predominantly determined by its levelized cost of producing each unit of base substance. In terms of the capital cost components of LCOC, OAE systems have an advantage over many NETs in that OAE systems are relatively inexpensive to construct and install, have a relatively small footprint and can be controlled using automated operating systems. Moreover, due to the high energy consumption and wear-related part replacement costs associated with performing the electrochemical salt-conversion process (described above), the most significant operating costs associated with an OAE system arise in the operation of the OAE system's BPED. Therefore, developments that reduce BPED operating costs arguably provide the most promising way to reduce OAE system LCOC.

The BPEDs currently utilized in OAE systems are referred to herein as 3-chamber BPEDs for brevity. Such 3-chamber BPEDs may be characterized by utilizing an electrodialysis apparatus having an ion exchange (IE) stack configured in a 3-chamber cell arrangement, and by utilizing a flow control system capable of directing three different aqueous solutions (i.e., a salt feedstock solution, an acid solution, and a base solution) through corresponding salt/acid/base chambers of the IE stack. The IE stack includes multiple 3-chamber cells arranged in series between opposing electrodes, where each 3-chamber cell includes salt, acid and base chambers that respectively serve as parallel flow channels for the aqueous salt, acid and base solutions as they pass through the IE stack (i.e., each cell includes a salt chamber that channels a portion of the salt feedstock solution, an acid chamber that channels a portion of the aqueous acid solution, and a salt/base chamber that channels a portion of the base solution). Each cell's salt chamber is disposed between and separated from the cell's acid and salt/base chambers by corresponding ion exchange membranes, which are configured to facilitate the transfer of sodium and chloride ions from the salt chamber into the base and acid chambers during the electrochemical process. That is, during the electrochemical process an electric field applied across the IE stack by the electrodes produces an ionic current in a direction perpendicular to the parallel flow paths, whereby anions in the salt/base/acid streams (e.g., chloride ions (Cl⁻) and hydroxide ions (OH⁻)) move toward the positive electrode (anode) and cations in the salt/base/acid streams (e.g., sodium ions (Nat) and protons (H⁺)) move toward the positive electrode (anode). This ionic current causes dissociated salt molecules (i.e., sodium ions (Na⁺) and chloride ions (Cl⁻)) to exit the salt feedstock stream in opposite directions (i.e., such that the chloride ions (Cl⁻) pass through a first ion exchange filter from the cell's salt chamber into the cell's acid chamber, and the sodium ions (Nat) pass through a second ion exchange filter into the acid chamber). The chloride ions (Cl⁻) then combine with protons (H⁺) to form “new” acid (HCl) molecules in the acid solution stream passing through each cell's acid chamber, and the sodium ions (Nat) combine with hydroxide ions (OH⁻) to form “new” base (NaOH) molecules in the base solution stream passing through each cell's salt/base chamber. As a result of this electrochemical salt-conversion process, the base solution exiting the IE stack, which combines the base solution flows exiting each of the cells, has a significantly higher concentration of base substance (e.g., NaOH molecules) than before entering the IE stack. Similarly, the acid solution exiting each cell has a higher concentration of acid substance (e.g., HCl molecules) than before entering the IE stack. That is, the 3-chamber IE stack arrangement is configured such that three separate streams exit the ED apparatus: a reduced-salt solution stream (i.e., having a lower salt content than the salt feedstock solution fed into the ED apparatus), an acid product (strong acid) stream including the “new” acid molecules, and a base product (strong base) stream including the “new” base molecules.

The main operational costs associated with 3-chamber BPEDs include the cost of externally supplied electricity and maintenance (e.g., replacement part and manual labor) associated with the IE stack, flow control system and other BPED subsystems required to perform the electrochemical salt-conversion process. A majority of the externally supplied electricity needed to power a given BPED operations is consumed by the IE stack (i.e., to generate the electric field that produces the ionic current) and varies in accordance with the BPED's IE stack arrangement. That is, larger capacity IE stacks (i.e., those capable of generating larger amounts of base substance per hour) typically require a larger number of series-connected cells. Although the salt/acid/base solutions are conductive, each ion exchange membranes functions like a resistor that impedes the applied electric field. Therefore, larger capacity IE stacks require larger amounts of externally supplied electricity to maintain an electric field at a suitably strong level across a larger number of cells (i.e., across a larger number of ion exchange membranes) than that required by smaller capacity IE stacks. Moreover, a significant amount is needed to power the flow control system (e.g., the various pumps and valves required to maintain the pressures and flow rates of the salt/acid/base solution streams) and other BPED subsystems, such as feedstock pretreatment units that are typically utilized to remove solids and other contaminants (e.g., divalent ions) from the aqueous salt feedstock solution (e.g., seawater) in order to reduce fouling (e.g., mineral scaling) in the IE stack. BPED maintenance costs include the cost of replacing parts that periodically wear out during normal BPED operations, costs associated with service/labor required to replace these parts, and costs associated with maintenance-related down-time (i.e., the periods of OAE system non-operation that are required to perform maintenance operations). Similar to the cost of externally supplied electricity, maintenance costs are typically higher for BPEDs with larger capacity IE stacks than BPEDs with lower capacity IE stacks due to the need to periodically replace a greater number of expensive ion exchange membranes and the higher expense associated with the replacement of flow control system and pretreatment unit components capable of the required higher flow capacities. Because the effectiveness of OAE systems as a NET is strongly dependent on minimizing LCOC (i.e., minimizing the levelized cost of producing base substance), and because the cost of externally supplied electricity and maintenance costs (e.g., the cost of ion exchange filters/membrane replacement) represent two of the most significant expenses associated with an OAE system's production of base substance, there is a strong motivation to optimize OAE system operations in a way that minimizes these two cost components.

Enhanced ocean weathering (EOW) represents another promising ocean capture approach that both reduces atmospheric CO₂ and mitigates ocean acidification. EOW involves spreading finely ground alkaline aggregate (e.g., silicate rock, such as basalt) onto large ocean surface areas. The widely dispersed alkaline aggregate captures large amounts of dissolved CO₂ while in contact with the ocean water. The alkaline aggregate then sinks below the surface, thereby storing the captured CO₂ in the ocean and slowing ocean acidification by way of direct interaction between the ocean's seawater and the alkaline material. A major challenge faced by EOW technologies is how to maximize CO₂ drawdown for a given amount of finely ground alkaline aggregate. Currently, the best strategies for addressing this challenge at scale involve crushing/grinding the alkaline rock into extremely small particles and then dispersing these particles over large areas of the ocean to maximize the ratio of surface area to dispersed volume. A problem with these EOW strategies is that both the crushing/grinding and dispersing processes require a significant amount of energy. As explained above, the effectiveness of EOW systems as a NET is strongly dependent on minimizing LCOC, and because the cost of externally supplied electricity to crush/grind the alkaline rock represents one of the most significant expenses associated with an EOW system, there is a strong motivation to optimize EOW system operations in a way that minimizes this cost component.

Seawater desalination is the process of removing salt and other contaminants from seawater, making it suitable for human consumption, irrigation, or industrial uses. Seawater desalination allows coastal communities to use a broader variety of water sources than conventional techniques, improving the resilience of water-stressed communities. Seawater desalination will become increasingly important as climate change threatens traditional water resources. As sea levels rise, existing freshwater aquifers for coastal communities are at an increasingly high risk of seawater intrusion, thereby making seawater desalination an important potential tool to help these communities adjust to climate change.

Seawater desalination systems utilize either thermal technologies or membrane-based technologies. Thermal desalination systems heat seawater so that H₂O evaporates into steam, leaving behind salt and other impurities, then condenses the steam back into liquid freshwater that is suitable for human consumption or other freshwater uses. Membrane-based desalination describes a class of technologies in which saline water passes through a semi-permeable material that allows H₂O through but holds back dissolved solids like salts. Reverse osmosis is the most common membrane-based desalination technology that reverses the natural osmosis process (i.e., the natural movement of freshwater from an area of low salt concentration to an area of high salt concentration) by utilizing high-energy pumps to pressurize seawater located on a first side of a semi-permeable material such that passes through the membrane to generate freshwater (sometimes referred to as permeate) on the opposing (second) side of the membrane and leaving behind high-salt content brine (i.e., aqueous solution having a significantly higher salt content than that of seawater) on the first side of the membrane. Note that the pressure required to force freshwater through a membrane is directly proportional to the feedstock solution's salt content (i.e., saltier water having a relatively high salt concentration requires more pressure than less salty water), but this pressure is limited by the strength of the membrane (i.e., the membrane will rupture if the pressure is too high). Therefore, the strength of the membrane effectively creates an upper limit on the salinity of water that can be treated at a given flow volume, and a feedstock solution having a salt content much higher than seawater typically cannot be purified using reverse osmosis technologies.

Problems associated with all seawater desalination technologies are related to the disposition of brine, high operating costs and carbon footprint. Both thermal and membrane-based desalination technologies generate brine having a higher salt concentration than seawater that is typically disposed of by supplying the brine into the ocean in a manner that both avoids ecological hazards (e.g., harm to sea life) and does not increase the salt content of the seawater feedstock drawn into the desalination plant (i.e., significant resources are required to disperse the brine over a large ocean region and far from the seawater feedstock input pipe). In addition, although the most efficient thermal desalination processes typically use more energy than membrane-based approaches, even reverse-osmosis seawater desalination consume large amounts of electrical energy (e.g., to drive seawater feed pumps and to achieve the pressures necessary to force permeate through semi-permeable membranes). This high energy consumption causes conventional seawater desalination plants to have both high operating costs and a large carbon footprint (i.e., due to the significant greenhouse gas emissions associated with the generation of the required electrical energy).

What is needed is a system/method that reduces seawater desalination system operating costs (i.e., external electricity and/or maintenance) and greenhouse gas emissions while avoiding the ecological hazards and other problems associated with brine disposition. What is also needed is a carbon dioxide removal (CDR) system/method that minimizes LCOC by way of significantly reducing the operating costs associated with conventional EOAE systems/methods (i.e., external electricity and/or maintenance costs) and/or EOW systems/methods (i.e., crushing/grinding costs).

### SUMMARY OF INVENTION

In an embodiment the present invention is directed to a modified desalination process and associated method that utilizes an electrochemical process to both mitigate the above-mentioned brine disposition problem and address other problems associated with conventional desalination systems/methods. Similar to conventional desalination processes, the modified desalination system/method is configured to convert a saltwater feedstock (e.g., brackish groundwater or seawater having an initial/first salt concentration) into a desired stream of freshwater (i.e., water suitable for human consumption, irrigation, or industrial uses) and a byproduct stream containing brine (i.e., saline solution having a relatively high (second) salt concentration that is higher than the initial salt content of the saltwater feedstock). According to an aspect, the modified electrochemical process is utilized to mitigate the above-mentioned brine disposition problem by effectively removing most of the salt from the brine stream in a way that effectively converts the brine stream into a reduced-salt stream having a relatively low (third) salt concentration that is lower than the initial (first) salt concentration of the saltwater feedstock. According to another aspect, at least some of the reduced-salt stream generated by the electrochemical process is mixed/combined with the saltwater feedstock (i.e., such that the saltwater feedstock is effectively diluted by the reduced-salt stream before performing the desalination process), thereby reducing freshwater production costs by reducing the amount of salt that must be filtered/removed from the saltwater feedstock during the desalination process (i.e., in comparison to conventional processes in which only saltwater feedstock is desalinated).

In an embodiment a modified desalination (or other) system includes an electrochemical reactor (e.g., a bipolar electrodialysis apparatus (BPED)), a mixing device and a desalination unit that are cooperatively coupled and configured to perform the modified desalination process mentioned above. The desalination unit utilizes known techniques to convert a saltwater feedstock having an initial (first) salt concentration into a freshwater stream and a brine stream having a relatively high (second) salt concentration, and the system is configured to direct (e.g., by way of pipes and pumps) the brine stream from an output terminal of the desalination unit to an input terminal of the electrochemical reactor. The electrochemical reactor is configured to channel three separate solutions: an aqueous salt solution that enters the reactor as the brine stream and exits as the reduced-salt stream, an aqueous acid solution that enters as a weak acid stream and exits as an acid product stream, and an aqueous base solution that enters as a weak base stream and exits as a base product stream. The electrochemical reactor is also configured to generate the reduced-salt stream by electrochemically processing the brine stream such that at least some of the salt molecules (e.g., NaCl) contained in the brine stream are converted into acid molecules (HCl) contained in the acid product stream and base molecules (NaOH) contained in a base product stream. According to another aspect, the electrochemical processing is performed at a rate that converts/removes a sufficient amount salt from the salt/saline solution such that the (third) salt concentration of the reduced-salt stream leaving the electrochemical reactor is lower than the initial (first) salt concentration of saltwater feedstock, thereby significantly reducing eco-safety risks and other brine disposition issues associated with conventional desalination systems/processes. According to another aspect, the system is further configured to direct (e.g., by way of pipes and pumps) at least some of the reduced-salt stream from the electrochemical reactor to an input terminal of the mixing device, which is configured to mix a saltwater feedstock stream (i.e., untreated feedstock or treated feedstock) with the reduced-salt stream received from the electrochemical reactor such that the resulting mixture stream has a (fourth) salt concentration that is lower than the initial (first) salt concentration of the saltwater feedstock, and the desalination unit is configured to generate the freshwater stream and the brine stream by processing the mixture stream (desalination fluid) exiting the mixing device. Mixing (combining) the saltwater feedstock with the reduced-salt stream provides the system with two cost-saving benefits over conventional desalination systems: first, the energy cost required to produce each unit of freshwater is reduced because the amount of raw seawater or briny groundwater that must be pumped from a saltwater feedstock source to the desalination unit is reduced by an amount equal to that of the reduced-salt stream; and second, the operating/maintenance costs of the system are reduced by reducing the amount of salt that must be filtered or otherwise separated from the desalinated fluid (i.e., the feedstock/reduced-salt mixture) by the desalination unit. Accordingly, by utilizing an electrochemical reactor to remove salt from the brine stream generated by the desalination process, and then utilizing the reduced-salt stream generated by the electrochemical reactor to supplement/dilute the saltwater feedstock directed into the desalination unit, the modified desalination system both mitigates the above-mentioned brine disposition problem and addresses other problems associated with conventional desalination systems.

In some embodiments, the system includes an optional pretreatment unit that is operably coupled between a saltwater feedstock source (e.g., ocean or well) and the mixing device, and is configured to remove solids and other contaminants from a stream (portion) of “raw” saltwater feedstock that has been pumped or otherwise delivered from the saltwater feedstock source (e.g., seawater pumped directly from an ocean or briny groundwater pumped from a well), and is further configured to deliver the resulting treated saltwater feedstock to the mixing device by way of the saltwater feedstock stream. In some embodiments the pretreatment unit includes filtering systems or other devices that function to remove solids and at least some contaminants (e.g., biological material and/or divalent ions) from the received raw saltwater feedstock. In an exemplary embodiment, the pretreatment unit includes one or more series connected filtering devices that utilize associated filters to remove contaminants from raw saltwater feedstock (e.g., a first filtering system that utilizes first filter(s) to remove solid particles from seawater, and a second filtering system that utilizes second filter(s) to selectively remove metals and/or biologic materials of value from the partially filtered seawater/brine received from the first filtering system). The filtered contaminants (e.g. removed solids, metals and/or biological materials) are removed from the feedstock flow path using known techniques, and the resulting treated (filtered) feedstock solution (i.e., the treated saltwater feedstock solution that has passed through the filters) forms the saltwater feedstock stream that is passed downstream to the mixing device for mixing with the reduced-salt stream received from the electrochemical reactor). In another exemplary embodiment, the pretreatment unit includes nanofiltration, ultrafiltration, chemical precipitation or other water purification system(s) that is/are configured to remove contaminants and reduce the hardness of the saltwater feedstock by filtering/removing dissolved metal ions and other hardness related minerals (e.g., calcium (Ca²⁺), magnesium (Mg²⁺), carbonate (CO₃)²⁻, and iron (Fe²⁺/Fe³⁺)), and the system may be configured to return the filtered/removed hardness related minerals to the ocean by way of the ocean alkalinity product. Utilizing the pretreatment unit further reduces operating and maintenance costs by extending the uninterrupted operating period of the desalination unit. Moreover, because the reduced-salt stream is utilized as described above to reduce the required amount of raw saltwater feedstock, the cost of maintaining pretreatment units is lower than that of conventional desalination systems (i.e., reducing the amount of saltwater feedstock passed through the pretreatment unit reduces the rate of filter replacement or other periodic maintenance). In some embodiments a second ion removal process (e.g., filtering similar to that used to remove harness related minerals) is applied to the byproduct brine stream leaving the desalination unit (i.e., before the brine stream is supplied to the electrochemical reactor 110E), thereby further reducing operating costs. In other embodiments, the pretreatment unit may be omitted, for example, in cases where the raw saltwater feedstock is sufficiently free of contaminants when delivered to the desalination system.

In some embodiments, the mixing device is configured to generate the mixture stream supplied to the desalination unit at a constant outflow rate by combining all of the reduced-salt stream received from the electrochemical reactor with a corresponding portion of the treated/untreated saltwater feedstock. As mentioned above, the salt content of the mixture stream exiting the mixing device is inversely proportional to the respective inflow rates of the reduced-salt stream and the saltwater feedstock, so minimizing the mixture stream's salt content (and thus minimizing desalination operating/maintenance costs) involves admitting as much of the reduced-salt stream as possible into the mixing device. In cases where the outflow rate of the mixture stream is determined by the combined reduced-salt stream and saltwater feedstock inflow rates, and is maintained constant (e.g., at the maximum processing rate of the desalination unit), the constant mixture stream outflow rate is achieved by admitting the total amount/inflow of the reduced-salt stream delivered to the mixing device and the controlling (i.e., increasing or decreasing) the saltwater feedstock inflow rate such that the combined inflow rates equal the constant mixture stream outflow rate. In some embodiments, a sensor monitors the flow rate of the reduced-salt stream delivered to the mixing device and a feedstock flow control device is utilized to control a (first) inflow rate of the saltwater feedstock stream into the mixing device, where the system controller controls the feedstock flow control device such that the (first) inflow rate is adjusted (increased/decreased) in accordance with changes (decreases/increases) in the (second) inflow rate of the reduced-salt stream into the mixing device. In some embodiments, the mixing device includes a mixing tank that receives the reduced-salt stream exiting the ED apparatus and a treated saltwater feedstock stream exiting a pretreatment unit such that the two streams intermix within the tank to form the mixture stream. In other embodiments, the mixing device may be implemented, for example, using interconnecting pipes or other mixing structures.

As set forth above, the desalination unit functions to desalinate the mixture stream received from the mixing device to generate freshwater and the high-salt brine/feedstock stream. In some embodiments, the desalination unit utilizes a known desalination device/process (e.g., thermal desalination or membrane-based desalination) to separate the mixture stream into the desired freshwater (permeate) stream and the byproduct brine stream. In an exemplary embodiment, the desalination unit utilizes a reverse osmosis (RO) system including a semi-permeable membrane that prevents the passage of salt molecules, whereby the brine stream is formed on one side of the membrane and permeate (freshwater) passes to the opposing side of the membrane. Similar to conventional desalination processes, the freshwater generated by the desalination unit has a suitably low salt concentration (e. g., ≤500 ppm), and the brine stream comprises an aqueous solution having salt content greater than 50,000 ppm (5%).

In an embodiment the electrochemical reactor is implemented using a bipolar electrodialysis system (BPED) of a type similar to that utilized in existing OAE systems to convert the high-salt brine stream into the reduced-salt stream. The BPED includes an electrodialysis (ED) apparatus that utilizes an ion exchange stack to perform an electrochemical salt-conversion process during which salt supplied in the brine stream is converted into a base substance and an acid substance. In some embodiments, the ion exchange stack comprising a series of salt chambers, acid chambers and base chambers that are arranged in series between opposing electrodes, where each salt chamber is located between and separated from associated pair of adjacent acid and base chambers by an associated intervening ion exchange membrane. The BPED also includes a flow control system including a first portion that is configured to direct the brine stream through the salt chambers of the ion exchange stack, a second portion configured to direct an aqueous acid solution through the acid chambers and a third portion configured to direct an aqueous base solution through the base chambers. During operation the opposing electrodes apply an electric field across the ion exchange stack to electrochemically process salt (e.g., NaCl) in the brine stream disposed in each salt chamber such that chlorine ions (Cl⁻) pass through first ion exchange membranes and combine with dissociated protons (H⁺) to form “new” acid molecules (HCl) in the aqueous acid solution disposed in the associated adjacent acid chamber, and such that sodium ions (Na⁺) pass through second ion exchange membranes and combine with dissociated hydroxide ions (OH⁻) to form “new” base molecules (NaOH) in the aqueous base solution disposed in the associated adjacent base chamber. In this manner, the electrochemical process causes the acid and base product streams leaving the ED apparatus to have a higher acid and base concentrations, respectively, than the acid/base solutions entering the ED apparatus. Conversely, the electrochemical process causes the reduction (removal) of salt from the brine solution passed through the ED apparatus, whereby the reduced-salt solution stream exiting the ED apparatus has a salt concentration that is substantially lower than that of the brine stream entering the ED apparatus. By utilizing a BPED similar to those used in stand-alone OAE systems (or another electrochemical reactor having a similar salt processing capacity), the reduced-salt solution can be generated with a salt concentration that is equal to or lower than that of seawater (e.g., below 35,000 ppm (3.5%)), thereby addressing the brine disposition issues associated with stand-alone desalination plants.

In some embodiments, the electrochemical reactor also includes a fluid buffering system including an acid buffer tank and a base buffer tank that facilitate the circulation of the aqueous acid and base solutions through the ED apparatus. Specifically, the acid buffer tank is configured to contain the aqueous acid solution that is directed (by way of associated flow control elements) into the acid (second) chamber(s) of the ion exchange stack and to receive a first portion of the acid product stream exiting (directed away from) the acid chambers(s). Similarly, the base buffer tank is configured to contain the aqueous base solution that is directed to the base (third) chamber(s) of the ion exchange stack and to receive a first portion of the base product stream exiting the base chamber(s). Note that second portions of the acid and base product streams are typically diverted for other purposes (e. g., maintenance, OAE or commercial sale). As mentioned above, the electrochemical reactor's flow control system is configured such that the brine stream exiting the desalination unit is directed to the ED apparatus, and at least a portion of the reduced-salt stream exiting the ED apparatus is directed to the mixing device. This salt solution flow arrangement differs from BPEDs utilized in conventional OAE systems in which the reduced/depleted salt stream exiting an ED apparatus is typically utilized to replenish (make up) any acid/base product diverted from the electrochemical reactor for other purposes and to control the acid/base concentration (dilution) of the weak acid and base solutions directed to the ED apparatus. To facilitate dilution of the acid and/or solution streams in cases where all of the reduced-salt stream is directed to the mixing device, in one embodiment, the flow control system is further configured to divert some of the freshwater stream exiting the desalination unit such that it flows into the acid buffer tank and/or the base buffer tank. Although utilizing some of the freshwater for acid and/or base dilution reduces the amount of freshwater output from the system, the required dilution amount is typically much less than that produced by the desalination unit, and may provide a net benefit, for example, in cases where high quality acid product is desired (i.e., the acid product's value is typically inversely proportional to the amount of salt in the acid solution). In other embodiments, replenishing for the acid and/or base product streams may be achieved using a portion of the reduced-salt stream or using a mixture of both freshwater and reduced-salt streams.

In some embodiments the brine stream exiting the desalination unit may be passed directly to the ED apparatus (i.e., the fluid buffer system may only include an acid buffer tank and a base buffer tank, and omit a salt buffer tank). In other embodiments, the fluid buffer system may include a salt buffer tank that is operably coupled between the desalination unit and the ED apparatus, and serves as a buffer for aqueous salt solution (i.e., such that a portion of the brine stream produced by the desalination unit is stored in the salt buffer tank). In this case, the salt buffer tank may be used to regulate the flow rate of brine into the ED apparatus.

In some embodiments, the electrochemical reactor is configured to process brine at a rate that corresponds with a desired maximum freshwater production rate. That is, a desalination unit that is capable of generating freshwater at a relatively high flow rate also generates brine at a relatively high flow rate, so, to avoid the buildup of unprocessed brine, the electrochemical reactor must be capable of converting the brine stream into a corresponding reduced-salt stream at a corresponding flow rate. In addition to suitable flow control and buffer resources, the electrochemical reactor's ED apparatus must be configured to receive and process brine at the corresponding flow rate, for example, by way of providing a sufficient number of cells (i.e., groups of salt, acid and base chambers separated by intervening ion exchange membranes) arranged in series between suitable electrodes, and otherwise configuring the ED apparatus to facilitate the conversion of brine at the relatively high flow rate.

In another exemplary embodiment, an integrated (combined) desalination/OAE system includes a seawater desalination subsystem and an OAE subsystem (electrochemical reactor). The seawater desalination subsystem generates a freshwater stream by desalinating seawater pumped or otherwise drawn from a nearby ocean using any of the desalination processes mentioned above. The OAE subsystem includes an ED apparatus that converts salt provided in the byproduct brine stream from the desalination process into acid and base product streams. The system also includes a post-production unit that selectively utilizes a portion of the base product stream to generate an ocean alkalinity product and selectively utilizes a portion of the acid product stream to generate an alkaline slurry, and then supplies (e.g., pumps) the ocean alkalinity product and the alkaline slurry to the ocean at a designated outfall location for OAE and enhanced ocean weathering (EOW) purposes (i.e., such that both the fully dissolved base substance in the ocean alkalinity product and the etched/weakened alkaline aggregate capture/reduce atmospheric carbon dioxide and mitigate ocean acidification). Integrating seawater desalination and at least one of OAE or EOW operations in the manner set forth herein essentially eliminates the ecological concerns associated with conventional stand-alone seawater desalination and significantly decreases total operating costs (i.e., in comparison with conventional stand-alone seawater desalination). That is, because the brine stream has a higher salt concentration than seawater, electrochemically processing the brine stream (i.e., in place of seawater) enhances the generation of ocean alkalinity product by decreasing the amount of externally supplied energy that is required to perform the electrochemical conversion of salt molecules (e.g., NaCl) into acid molecules (e.g., HCl) and base molecules (e.g., NaOH) for a given flow rate through the electrochemical reactor, thereby increasing the base product production efficiency and decreasing total operating cost over conventional stand-alone OAE systems that process seawater, thereby reducing LCOC in comparison to such OAE systems. Moreover, by generating and supplying alkaline ocean product and alkaline slurry to the ocean, the resulting OAE effectively offsets the carbon footprint of the seawater desalination process, and the integrated desalination/OAE system achieves greatly reduces total operating costs over separate (stand-alone) desalination and OAE plants. In addition, utilizing the reduced-salt stream, which is generated as a byproduct of the OAE process, to supplement the seawater (saltwater feedstock) processed by the desalination subsystem reduces operation and maintenance costs over conventional stand-alone seawater desalination plants, for example, by reducing the amount of raw seawater that must be pumped from an ocean and pretreated before desalination. Further, utilizing an electrochemical reactor to process the brine stream that is generated as a byproduct of the desalination process provides additional advantages including: (1) reducing environmental issues and dispersion costs associated with releasing high-salt-content brine directly from the desalination process into an ocean; and (2) reduces maintenance costs by facilitating the use of the generated acid product (e.g., HCl), e.g., to clean semi-permeable and/or ion exchange membranes utilized in the ion exchange stack. Moreover, integrating seawater desalination and OAE subsystems facilitates other benefits such as capital expense reductions achieved by shared plant facilities (e.g., project site and shelter/building), shared saltwater feedstock intake/outfall structures and associated operating costs, shared water treatment operating costs, and shared electrical infrastructure. Further, permitting (government authorization) for desalination plants is difficult in some regions because of eco-safety risks that are primarily due to the increased salinity of the outfall brine—the present invention mitigates this eco-safety risk by utilizing an electrochemical reactor to process the brine such that its final salinity is closer to ambient conditions, thereby leading to an easier permitting process for desalination plants modified in the manner described herein.

Although described herein with specific reference to specific modified desalination and integrated desalination/OAE/EOW systems/methods, the present invention may also be utilized to provide other commercially advantageous operations that may achieve at least some of the benefits set forth above. For example, the base product and/or acid product generated by the electrochemical reactor/process may be selectively utilized for non-OAE uses. Although the carbon footprint of the resulting desalination system/process may be higher than that of the combined desalination/OAE approach, the desalination system/process would still have advantages over conventional seawater desalination operations. That is, utilizing the electrochemical reactor to reduce the salt content of the high-salt brine/feedstock stream significantly reduces eco-safety risks and other issues associated with the disposition of the high-salt brine generated by conventional desalination processes. In an exemplary embodiment, the system's controller may monitor one or more sites that provide input data including spot pricing for the base product and/or acid product generated by the electrochemical reactor. The controller may then utilize this input data to determine whether the base and/or acid products should be utilized for OAE/EOW purposes, or whether they should be sold to a third-party buyer. For example, when sufficient low/zero-carbon electricity is available from a power grid to offset the desalination process carbon footprint and the base product spot price is sufficiently high, then the controller may direct the post-production unit to divert the base product (e.g., some or all of the second base stream portion) for sale to a third-party buyer (i.e., instead of directing the base product to the ocean as part of ocean alkalinity product), whereby proceeds from the sale serve to reduce total operating costs of the system. Similarly, the control algorithm implemented by the system's controller may monitor input data from one or more sites that provide spot pricing for the acid product (e.g., HCl) generated by the electrochemical reactor, and utilizes this data to determine whether it is more cost effective to neutralize the acid product (e.g., by way of enhanced ocean weathering), or if selling the acid product may produce a greater value (i.e., if the acid product spot price is sufficiently high), in which case the controller may direct the post-production unit to divert the acid product (e.g., some or all of the second acid stream portion) for sale to a third-party buyer.

According to another embodiment, a hybrid carbon dioxide removal (CDR) system includes an electrochemical OAE subsystem configured to generate an ocean alkalinity product, an EOW subsystem configured to generate an alkaline slurry, and a base delivery subsystem configured to supply at least one of the ocean alkalinity product and the alkaline slurry to an ocean to capture/reduce atmospheric carbon dioxide and mitigate ocean acidification. The electrochemical OAE subsystem utilizes an ED device configured to electrochemically process/convert salt into an acid substance and base substance and utilizes an alkaline product generator to generate an ocean alkalinity product including the base substance. In an exemplary embodiment, the EOW subsystem includes an accelerated ocean weathering reaction apparatus and a slurry generator. The accelerated ocean weathering reaction apparatus is configured to combine the acid substance from the electrodialysis device with an alkaline aggregate such that an accelerated ocean weathering reaction between the alkaline aggregate and the acid substance both neutralizes the acid substance and etches/weakens the alkaline aggregate. The slurry generator then receives the neutralized (fully processed) process fluid exiting the reaction apparatus and processes the etched/weakened alkaline aggregate into fine particles, thereby forming the alkaline slurry. In some embodiments, metal elements are released from the alkaline aggregate during the accelerated weathering and slurry generation processes and are reclaimed from the alkaline slurry to offset operating costs. The base delivery subsystem is configured to supply at least one of the ocean alkalinity product and the alkaline slurry to the ocean. By utilizing the acid substance of the electrochemical process to etch/weaken the alkaline aggregate, the accelerated (electrochemically assisted) ocean weathering process implemented by the EOW subsystem produces alkaline slurry at a significantly reduced cost in comparison to conventional EOW systems. That is, the acid substance, which is a byproduct of the electrochemical process and is therefore essentially cost free, serves to etch/weaken the alkaline aggregate, thereby increasing the etched/weakened aggregate's specific surface area and/or facilitating crushing/grinding the etched/weakened aggregate into alkaline particles suitable for ocean dispersal offsetting energy than would be required by conventional EOW crushing/grinding operations. Moreover, during the accelerated weathering operation the alkaline material in the alkaline aggregate neutralizes the acid substance, thereby circumventing acid storage/neutralization issues associated with conventional OAE technologies. Further, by supplying both the electrochemically generated ocean alkalinity product and the alkaline slurry to the ocean, the hybrid CDR system achieves at least the same amount of carbon capture removal and ocean deacidification as that achieved by independently operated conventional OAE and EOW systems using significantly less energy than separate conventional OAE and EOW systems. In some embodiments the CDR system utilizes a desalination subsystem to convert seawater from the ocean into a high-salt-content brine in order to enhance the electrochemical process.

### BRIEF DESCRIPTION OF THE DRAWINGS

FIG. 1 shows a modified desalination system according to an exemplary embodiment of the present invention;

FIG. 2 shows a simplified electrochemical reactor that may be utilized to electrochemically process a brine solution in the modified desalination system of FIG. 1, according to an exemplary specific embodiment;

FIG. 3 shows a simplified electrodialysis apparatus that may be utilized by the electrochemical reactor of FIG. 2 to electrochemically convert salt into acid and base products according to another exemplary embodiment;

FIG. 4 shows a modified desalination system according to another exemplary embodiment; and

FIG. 5 shows an integrated desalination/OAE/EOW system according to another exemplary embodiment of the present invention; and

FIG. 6 shows an EOW subsystem of the integrated desalination/OAE/EOW system of FIG. 5 in additional detail according to an exemplary embodiment.

### DETAILED DESCRIPTION

The present invention combines desalination and electrochemical systems/processes in a way that converts a saltwater feedstock (e.g., seawater or briny groundwater) into freshwater suitable for human consumption and other freshwater uses, a base substance suitable for OAE purposes, and an acid substance. The invention is primarily described herein with specific reference to a modified desalination system/method that utilizes a desalination subsystem/process to convert saltwater feedstock into freshwater and brine and utilizes an electrochemical reactor/process to convert the brine into a reduced salt solution (i.e., by converting salt in the brine into acid and base substances). In one embodiment, the invention is described with reference to an integrated desalination/OAE/EOW system/method that desalinates seawater to produces freshwater and brine, electrochemically processes the brine to generate acid and base products, utilizes the base product to perform an OAE process, and utilizes the acid product to reduce the energy costs associated with crushing/grinding alkaline aggregate in an EOW process. However, in some embodiments, the systems/methods described herein may be utilized for other purposes, including a stand-alone hybrid HDR system/method or a system/method for generating acid and/or base substances in remote locations. The following description is presented to enable one of ordinary skill in the art to make and use the methods and systems described herein as provided in the context of specific embodiments. Various modifications to the embodiments will be apparent to those with skill in the art, and the general principles defined herein may be applied to other embodiments. Therefore, the methods and systems described herein are not intended to be limited to the particular embodiments shown and described, but are to be accorded the widest scope consistent with the principles and novel features herein disclosed.

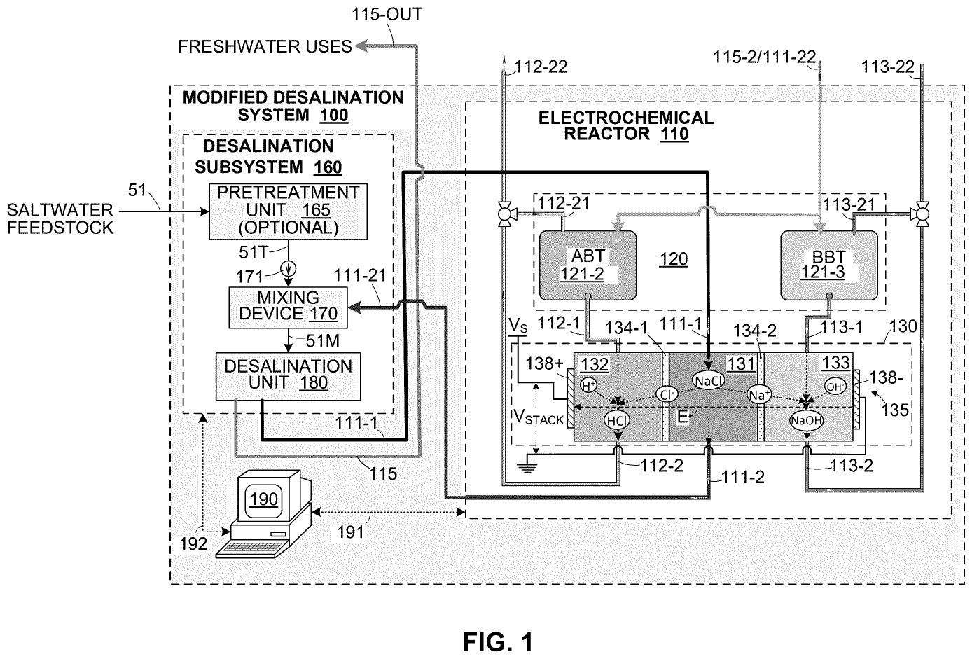

FIG. 1 depicts a modified desalination system 100 including an electrochemical reactor 110, a desalination subsystem 160 and a system controller 190. Electrochemical reactor 110 performs an electrochemical process in which a high-salt-content brine stream 111-1 is received from the desalination subsystem 160, salt contained in brine stream 111-1 is electrochemically processed (removed), and then at least a portion 111-21 of the resulting reduced-salt stream 111-2 is directed back to desalination subsystem 160. Desalination subsystem 160 performs a modified desalination process in which a mixing device 170 mixes (combines) a saltwater feedstock stream 51T (e.g., seawater or briny groundwater) with reduced-salt stream portion 111-21 received from electrochemical reactor 110 to form a mixture stream 51M, and then a desalination unit 180 processes (desalinates) mixture stream 51M to generate a freshwater stream 115 (i.e., water suitable for human consumption, irrigation, or industrial uses) and brine stream 111-1, which is directed to electrochemical reactor 110. System controller 190 controls the various operations performed by electrochemical reactor 110 and desalination subsystem 160 such that at least a portion of freshwater 115 exiting desalination subsystem 160 is directed out of system 100 as freshwater output stream 115-OUT for fresh water uses. Additional details regarding the various components and processes of system 100 are set forth below.

Referring to the left side of FIG. 1, desalination subsystem 160 includes an optional pretreatment unit 165, a mixing device 170 and a desalination unit 180 that process saltwater feedstock 51 to generate freshwater stream 115 and brine stream 111-1.

Optional pretreatment unit 165 is configured to treat a “raw” saltwater feedstock stream 51 (i.e., feedstock received directly from an external source, such as raw seawater pumped from an ocean 50, or briny groundwater pumped from a well) by removing (e.g., filtering) solids and other contaminants (e.g., biological material and/or divalent ions) from the raw feedstock. The resulting treated saltwater feedstock exiting pretreatment unit 165 is then supplied to mixing device 170 as saltwater feedstock stream 51T. Note that optional pretreatment unit 165 does not significantly reduce or otherwise change the salt content of the saltwater feedstock (i.e., the treated saltwater forming saltwater feedstock stream 51T has substantially the same initial (first) salt concentration as the raw saltwater forming feedstock stream 51. Pretreatment unit 165 may be omitted, for example, is cases where raw saltwater feedstock stream 51 is sufficiently pure (i.e., free of contaminants), or in embodiments where the raw saltwater feedstock is treated prior to being delivered into desalination subsystem 160. When pretreatment unit 165 is omitted, raw saltwater feedstock is passed directly to mixing device 170 (i.e., saltwater feedstock stream 51T and raw saltwater feedstock stream 51 comprise the same saltwater feedstock stream).

Mixing device 170 is configured to receive reduced-salt stream portion 111-21 from electrochemical reactor 110 (i.e., some or all of reduced-salt stream 111-2 exiting ED apparatus 130) and saltwater feedstock stream 51T from pretreatment unit 165. Mixing device 170 utilizes one or more mechanisms (e.g., a mixing tank and/or pumps) to mix (combine) the two streams and to produce a mixture stream 51M including a mixture solution having a (fourth) salt concentration that is between the initial (first) salt concentration of saltwater feedstock stream 51T and an intermediate (third) salt concentration of the reduced-salt stream 111-21. As described in additional detail below, electrochemical reactor 110 is configured to generate reduced-salt stream 111-2 such that the intermediate (third) salt concentration is lower than the initial (first) salt concentration of saltwater feedstock stream 51T. Therefore, mixture stream 51M comprises an aqueous solution having a salt concentration that is lower than the initial salt concentration of the saltwater feedstock. An outlet of mixing device 170 is operably coupled to an inlet of desalination unit 180 such that mixture stream 51M is directed into desalination unit 180. In some embodiments (not shown), the mixing process performed by mixing device 170 may be implemented by either optional pretreatment unit 165 or desalination unit 180.

In some embodiments mixing device 170 is configured to generate mixture stream 51M by combining all of reduced-salt stream 111-21 received from electrochemical reactor 110 with a corresponding portion of the treated/untreated saltwater feedstock included in saltwater feedstock stream 51T. That is, the flow rate of mixture stream 51M exiting mixing device 170 is substantially equal to a sum of the inflow rate of reduced-salt stream 111-21 received from electrochemical reactor 110 and the inflow rate of saltwater feedstock stream 51T. In this preferred embodiment, mixture stream 51M includes the total amount of reduced-salt stream 111-21 received from electrochemical reactor 110 and adjusts, if necessary, the inflow rate of saltwater feedstock stream 51T (e.g., by way of a feedstock flow control device 171). For example, assuming desalination unit 180 is configured to process mixture stream 51M at a total flow rate of 100 units per minute, if electrochemical reactor 110 provides reduced-salt stream 111-21 to mixing device 170 at an inflow rate of 30 units/min then the corresponding inflow rate of saltwater feedstock stream 51T is adjusted to equal 70 units/min, and if electrochemical reactor 110 subsequently provides reduced-salt stream 111-21 at an inflow rate of 35 units/min then the corresponding inflow rate of saltwater feedstock stream 51T is adjusted to 65 units/min. Utilizing all of the available reduced-salt stream 111-21 to generate mixture stream 51M minimizes the amount of salt that must be removed from mixture stream 51M by desalination unit 180 (i.e., by minimizing the proportion of saltwater feedstock to reduced-salt solution in mixture stream 51M). Note that variations in the inflow rate of reduced-salt stream 111-21 may occur for purposes of project wide optimization. For example, when acid production is valued higher than freshwater and base production, then freshwater stream portion 115-2 may be directed to acid buffer tank 121-2 (i.e., to increase the value of acid product stream 112-2 by minimizing salt content), whereby more of reduced-salt stream 111-2 may be directed to mixing device 170 as reduced-salt stream portion 111-21. In other cases it may be determined that freshwater and/or base production may be optimized when both freshwater stream portion 115-2 and reduced-salt stream 111-22 are simultaneously directed to acid buffer tank 121-2 and/or base buffer tank 121-3, where the system controller adjusts the fractions of the freshwater and reduced-salt streams to optimize the salt content in the acid and base solutions. In other embodiments, system optimization may be achieved by replenishing (making-up) for the acid product stream 112-22 and/or base product stream 113-22 using only reduced-salt stream portion 111-22 with the remainder of reduced-salt stream 111-2 being directed to mixing device 170 as reduced-salt stream portion 111-21. Whenever system optimization requires a corresponding change (increase/decrease) in the inflow rate of salt stream portion 111-21 to mixing device 170, the system controller makes a corresponding adjustment (decrease/increase) to the inflow rate of saltwater feedstock stream 51T so that the outflow rate of mixture stream 51M remains constant.

Desalination unit 180 is configured to perform a desalination process on mixture stream 51M in a manner that generates high-salt brine stream 111-1, which is then directed to electrochemical reactor 130, and freshwater stream 115 comprising water having a salt concentration that is suitable for human consumption (e.g., less than or equal to 0.05% (≤500 ppm). By way of example, when the saltwater feedstock comprises seawater pumped from an ocean, saltwater feedstock stream 51/51T has a salt concentration of about 3.5%, the relatively high salt concentration of brine stream 111-1 may be greater than 5%. As described in additional detail below, in alternative embodiments desalination unit 180 may be implemented using a thermal desalination system, a reverse osmosis system or another membrane-based (or other) desalination system.

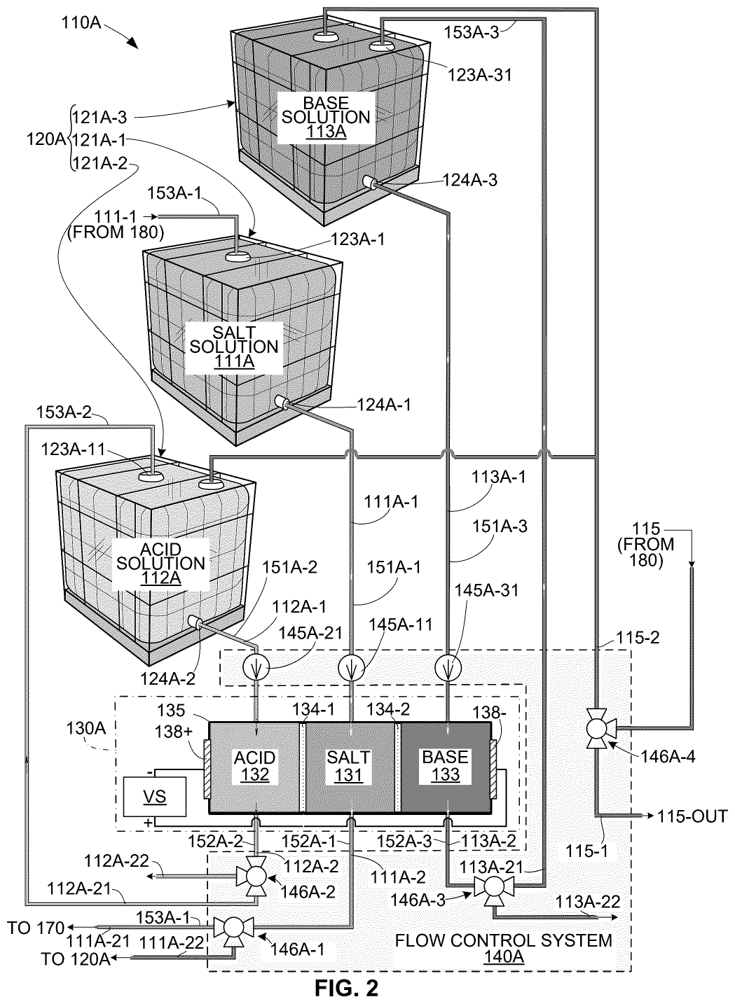

Referring to the right side of FIG. 1, electrochemical reactor 110 includes a fluid buffering system 120, an electrochemical reactor 130 and a flow control system. As set forth in additional detail below, electrochemical reactor 110 is configured to generate reduced-salt stream 111-2 by electrochemically processing the brine stream 111-1 such that at least some of the salt molecules (e.g., NaCl) contained in brine stream 111-1 are converted into acid molecules (e.g., HCl) contained in an acid product stream 112-2 and base molecules (NaOH) contained in a base product stream 113-2, and such that the reduced-salt stream 111-2 exiting the electrochemical reactor 110 has a relatively low (third) salt concentration that is lower than the initial (first) salt concentration of the saltwater feedstock. Note that electrochemical reactor 110 is greatly simplified for descriptive purposes, and that additional details regarding its construction and operation are provided below with reference to the exemplary embodiments depicted in FIGS. 2 to 5.

Fluid buffering system 120 includes an acid buffer tank (ABT) 121-2 and a base buffer tank 121-3. Acid buffer tank 121-2 is configured to contain an aqueous acid solution that is circulated through reactor 130 by way of associated flow control structures (e.g., pipes and pumps) such that a relatively weak acid stream 112-1 is directed from acid buffer tank 121-2 to reactor 130 and at least a portion 112-21 of a relatively strong acid product stream 112-2 leaving reactor 130 is directed back to acid buffer tank 121-2. Base buffer tank 121-3 is configured to contain an aqueous base solution that is circulated through reactor 130 by way of associated flow control structures such that a relatively weak base stream 113-1 is directed from base buffer tank 121-3 to reactor 130 and at least a portion 113-21 of a relatively strong base product stream 113-2 leaving reactor 130 is directed back to base buffer tank 121-3. In some embodiments, the flow control system is further configured to direct a portion 115-2 of freshwater 115 into one or more of acid buffer tank 121-2 and base buffer tank 121-3 to dilute the weak solutions directed into reactor 130.

ED apparatus 130 generally includes an ion exchange (IE) stack 135 that is disposed between two electrodes (i.e., anode 138+ and cathode 138−). IE stack 135 typically includes multiple cells arranged in series between electrodes 138+ and 138−, where each cell includes three chambers that respectively serve as parallel flow channels for the aqueous salt, acid and base solutions as they pass through IE stack 135. For brevity and clarity, only one cell of IE 135 is depicted in FIG. 1, which is made up of a salt chamber 131 that functions to channel a portion of the aqueous salt solution, an acid chamber 132 that channels a portion of the aqueous acid solution, and a base chamber 133 that channels a portion of the aqueous base solution. Each cell's salt chamber 131 is disposed between and separated from the cell's acid chamber 132 and base chamber 133 by corresponding ion exchange membranes 134-1 and 134-2, which are configured to facilitate the transfer of sodium and chloride ions from the salt chamber into the base and acid chambers during the electrochemical process as described below. ED apparatus 130 also includes manifold or other structures (not shown) that are configured to cooperate with the flow control resources of BPED 110 to direct the three different (i.e., a salt, acid and base) aqueous solutions through corresponding salt/acid/base chambers of IE stack 135. Specifically, the aqueous salt solution enters IE stack 135 as brine stream 111-1 that is divided and directed (e.g., by an input manifold, not shown) into the inlet of each cell's salt flow channel 131, and the aqueous salt solution exits the IE stack 135 by way of an outlet of each cell's salt flow channel 131 (and an outlet manifold, not shown) as reduced-salt stream 111-2. Similarly, the aqueous acid solution enters IE stack 135 as a weak acid stream 112-1 that is directed into the inlet of each cell's acid flow channel 132 and exits the IE stack 135 by way of an outlet of each cell's acid flow channel 132 as acid product stream 112-2. Finally, the aqueous base solution enters IE stack 135 as a weak base stream 113-1 that is directed into the inlet of each cell's base flow channel 133 and exits the IE stack 135 by way of an outlet of each cell's base flow channel 133 as base product stream 113-2.

During the electrochemical process the three (salt, acid and base) aqueous solutions are directed through IE stack 135 along parallel flow paths (e.g., in the vertical direction) while a stack voltage V_{STACK} is applied to electrodes 138+ and 138−. When stack voltage V_{STACK} is sufficiently strong, the resulting electric field E produces an ionic current across IE stack 135 in a direction perpendicular to the parallel flow paths (e.g., in the horizontal direction). This ionic current causes dissociated salt molecules (i.e., sodium ions (Na⁺) and chloride ions (Cl⁻)) to exit brine stream 111-1 in opposite directions (i.e., such that the chloride ions (Cl⁻) pass through ion exchange filter 138-1 from salt chamber 131 into the acid chamber 132, and the sodium ions (Nat) pass through ion exchange filter 138-2 into base chamber 133). The chloride ions (Cl⁻) then combine with protons (H⁺) to form “new” acid molecules (HCl) in the acid solution stream flowing through acid chamber 132, and the sodium ions (Na⁺) combine with hydroxide ions (OH⁻) to form “new” base molecules (NaOH) in the base solution stream flowing through base chamber 133. As a result of this electrochemical salt-conversion process, base product stream 113-2 exits each cell's base chamber 133 with a significantly higher concentration of base molecules than weak base stream 113-1 (i.e., the aqueous base solution before it enters IE stack 135). Similarly, acid product stream 112-2 exiting each cell's acid chamber 132 has a higher concentration of acid molecules than that of weak acid stream 112-1. Note that, because salt is converted (consumed) to generate the acid and base molecules, reduced-salt stream 111-2 exiting each cell's salt chamber 131 has a lower salt concentration than inflowing brine stream 111-1.

Referring to the lower left portion of FIG. 1, system controller 190 controls the various operations performed by electrochemical reactor 110 by way of operation/control signals 191, and controls the various operations performed by desalination subsystem 160 way of operation/control signals 192 such that at least a portion of the freshwater 115 exiting desalination unit 180 is directed out of system 100 as freshwater output stream 115-OUT. In an embodiment system controller 190 controls the operating state of ED apparatus 130 such that the above-described electrochemical process is performed at a rate that converts/removes a sufficient amount salt from brine stream 111-1 such that reduced-salt stream 111-2 leaving electrochemical reactor 110 has a relatively low (third) salt concentration that is lower than the initial (first) salt concentration of the saltwater feedstock. In some embodiments system controller 190 controls a flow rate of mixture stream 51M into desalination unit 180 using sensor data from sensors configured to measure the flow rate of reduced-salt stream portion 111-21 (i.e., some or all of reduced-salt stream 111-2) from electrochemical reactor 110 into mixing device 170 and using a feedstock flow control device (e.g., pump or valve) to control the associated flow rate of saltwater feedstock stream 51T into mixing device 170. Note that, because the salt concentration of reduced-salt stream 111-2 is lower than the initial (first) salt concentration of saltwater feedstock 51/51T, any non-zero flow rate of reduced-salt stream portion 111-21 into mixing device 170 causes the solution forming mixture stream 51M to have a (fourth) salt concentration that is lower than the initial (first) salt concentration of saltwater feedstock 51/51T. Therefore, although operational and maintenance costs associated with desalination subsystem 160 may be reduced by way of directing all (i.e., the totality of) reduced-salt stream 111-2 from ED apparatus 130 to mixing device 170, beneficial reductions in total system operating costs may be achieved when reduced-salt stream portion 111-21 includes less than all of reduced-salt stream 111-2, and the remaining portion is redirected for other purposes (e.g., reduced-salt stream portion 111-22 may be used in place of or in combination with freshwater portion 115-2 to replenish (make-up) the acid and base solutions stored in buffer tanks 121-2 and 121-3). In some embodiments, system controller 190 is implemented using one or more processors configured to implement a software-based control algorithm that utilizes one of a proportional integral derivative, machine learning and/or artificial intelligence to coordinate the desalination and OAE processes (described below). In some embodiments, controller 190 controls the operations performed by electrochemical reactor 110 to perform additional functions described in co-owned U.S. Pat. No. 11,629,067, cited above.

FIG. 2 shows a generalized bipolar electrodialysis (BPED) system (electrochemical reactor) 110A of a type similar to that utilized in some Ocean alkalinity enhancement (OAE) systems. BPED 110A generally includes a fluid buffering system 120A, an ED apparatus 130A, a flow control system 140A and a series of flow lines that are described in additional detail below. Additional details of BPED 110A are provided in U.S. Pat. No. 11,629,067, entitled “OCEAN ALKALINITY SYSTEM AND METHOD FOR CAPTURING ATMOSPHERIC CARBON DIOXIDE”, which is incorporated herein by reference in its entirety.

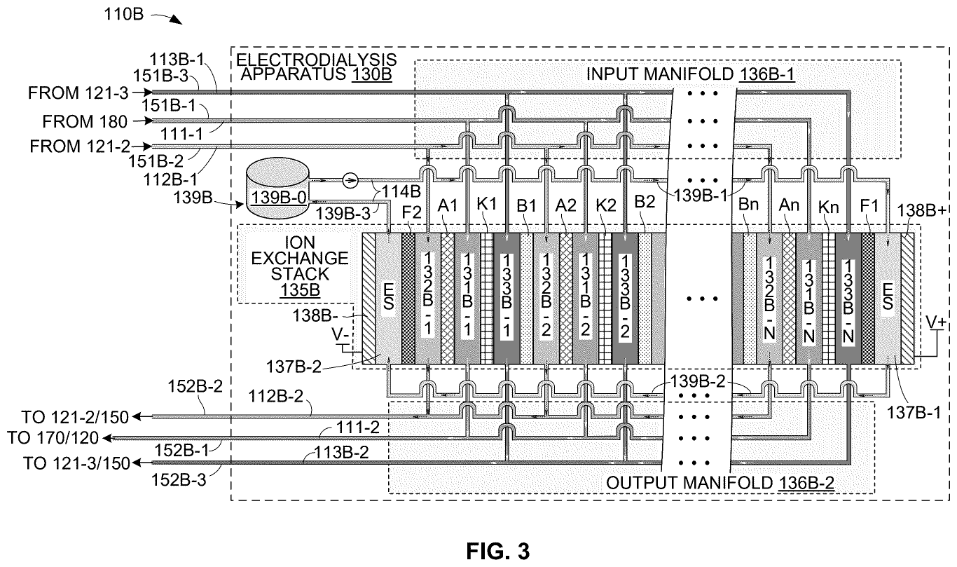

Referring to the upper portion of FIG. 3, fluid buffering system 120A includes an optional salt buffer tank 121A-1 utilized to receive and store brine stream (salt solution) 111-1, an acid buffer tank 121A-2 utilized to store an acid solution 112A, and a base buffer tank 121A-3 utilized to store a base solution 113A. Each buffer tank 121A-1 to 121A-3 can be implemented using a standard 1000 L IBC caged tote tank, where salt buffer tank 121A-1 includes a plastic containment unit 122A-1 having an inflow port 123A-1 operably coupled to receive brine stream 111-1 and an outflow port 124A-1 operably coupled to salt chamber(s) 131 of ion exchange stack 135, acid buffer tank 121A-2 includes a plastic containment unit 122A-2 having an inflow port 123A-21 operably coupled to receive acid product stream portion 112A-21 and an outflow port 124A-2 operably coupled to acid chamber(s) 132 of ion exchange stack 135, and base buffer tank 121A-3 includes a plastic containment unit 122A-3 having an inflow port 123A-31 operably coupled to receive base product stream portion 113A-21 and an outflow port 124A-3 operably coupled to base chamber(s) 133 of ion exchange stack 135. Portions of freshwater output stream 115 generated by desalination unit 180 (shown in FIG. 1) and/or portions of reduced-salt stream 111A-2 may be directed to buffering system 120A and utilized to dilute and maintain acid solution 111A and base solution 113A at suitable levels within buffer tanks 121A-2 and 121A-3.

Electrodialysis apparatus 130A includes ion exchange stack 135 and is otherwise configured and operates as described above with reference to FIG. 1 to electrochemical process NaCl (salt) molecules provided in brine stream 111-1 such that Cl-ions pass from salt chamber 131 though ion exchange membrane 134-1 into acid chamber 132 to enhance (i.e., decrease the pH of) acid solution 112A, and such that Nat ions pass from salt chamber 131 though ion exchange membrane 134-2 into base chamber 133 to enhance (i.e., increase the pH of) base solution 113A. Ion exchange stack 135 can be surrounded by a water-tight containment housing (not shown) to facilitate the flow of salt solution 111A through salt chamber(s) 131, the flow of acid solution 112A through acid chamber(s) 132, and the flow of base solution 113A through base chamber(s) 133. Cathode 138A− and anode 138A+ are disposed at opposite ends of ion exchange stack 135 and generate an electric field through the chambers in response to an applied voltage differential provided by a suitable voltage source VS, thereby electrochemically processing the salt, acid and base streams in the manner described herein.

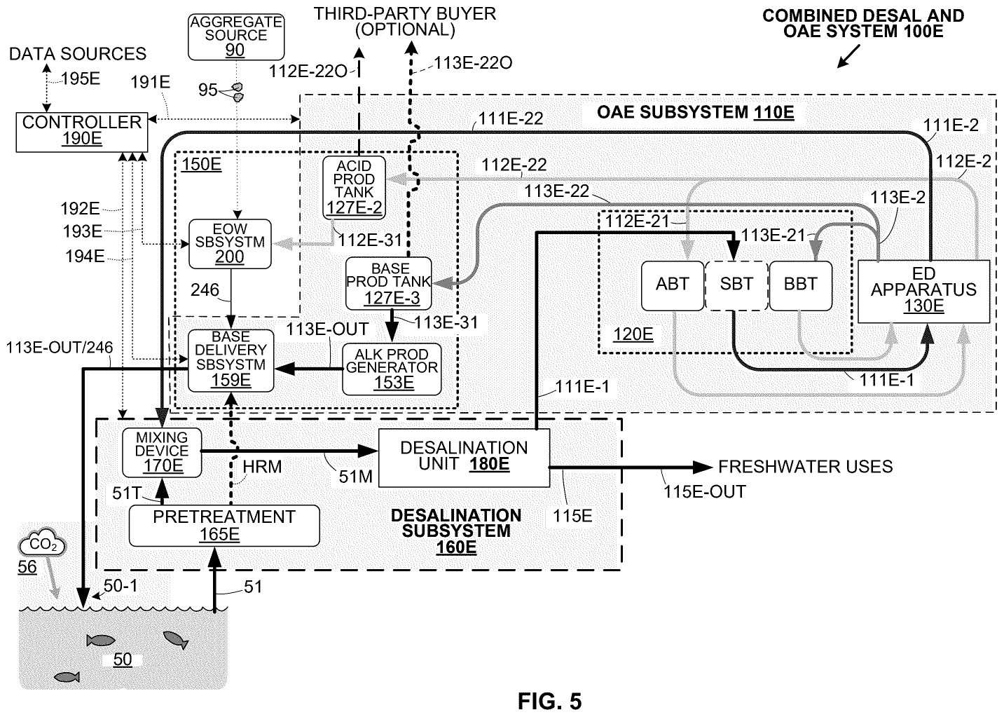

Similar to BPEDs utilized in OAE systems, flow control system 140A includes various control elements (e.g., pumps, valves etc.) that are collectively configured to direct streams of the acid and base solutions from buffer tanks 121A-2 and 121A-3 through corresponding chambers 132 and 133 of electrodialysis apparatus 130A and then back to buffer tanks 121A-2 to 121A-3 by way of associated conduits (flow lines). Specifically, weak acid stream 112A-1 exits acid buffer tank 121A-2 and is directed into acid chamber 132A by way of acid inflow line 1501A-2 and a pump 145A-21, and strong acid stream 112A-2 exits acid chamber 132A by way of acid outflow line 152A-2, with a first portion 112A-21 being returned to acid buffer tank 121A-2 by way of optional three-way valve 146A-2 and acid return line 153A-2, and a second portion 112A-22 of strong acid stream 112A-2 being diverted out of BPED 110A, e.g., for system maintenance purposes or commercial sale. Similarly, weak base stream 113A-1 exits base buffer tank 121A-3 and is directed into base chamber 133A by way of base inflow line 151A-3 and a pump 145A-31, a portion 113A-21 of strong base stream 113A-2 exiting base chamber 133A by way of base outflow line 152A-3 is returned to base buffer tank 121A-3 by way of three-way valve 146A-3 and a base return line 153A-3, and a second portion 113A-22 of strong base stream 113A-2 is diverted out of BPED 110A, e.g., for OAE purposes (e.g., as described below with reference to FIG. 5) or for commercial sale.

BPED 110A differs from BPEDs typically utilized in OAE systems in that, unlike the acid and base solutions, flow control system 140A does not circulate all of weak salt solution exiting ion exchange stack 135 back to the acid/base buffer tanks. Instead, flow control system 140A is configured to direct brine stream 111-1 into salt chamber(s) 131 and to direct at least a portion 111A-21 of reduced-salt stream 111A-2 from salt chamber(s) 131 to mixing device 170 (shown in FIG. 1). Specifically, brine stream 111A-1 exits (flows from) salt buffer tank 121A-1 by way of outflow port 124A-1 and is directed into salt chamber 131 by way of salt inflow line 151A-1 and a first pump 145A-11, and reduced-salt stream 111A-2 exits salt chamber 131 by way of salt outflow line 152A-1. A valve 146A-1 is controlled by the system controller to direct a first portion 111A-21 of reduced-salt stream 111A-2 to mixing device 170 by way of an optional and an associated flow line 153A-1. A benefit of this arrangement is that, when ED apparatus 130A is operated such that reduced-salt stream 111A-2 has a salt concentration lower than that of the saltwater feedstock, less saltwater feedstock must be pumped to and processed by the desalination subsystem (not shown in FIG. 2), thereby reducing both operating energy and maintenance costs in at least some cases. Flow control system 140A also includes an optional valve 146A-4 that controllable by the system controller to direct a first portion 115-1 of freshwater stream 115 (received from desalination unit 180, see FIG. 1) for use as freshwater output stream 115-OUT, and directs second portion 115-2 of freshwater stream 115 to buffering system 120A (i.e., into one or both of acid buffer tank 121A-2 and base buffer tank 121A-3 to replenish acid/base product diverted from electrochemical reactor 110A for other purposes). Note that valve 146A-1 is also controllable to selectively direct a second portion 111A-22 of reduced-salt stream 111A-2 to fluid buffering system 120A for similar reasons.

FIG. 3 shows a portion of a BPED system 110B including an ED apparatus 130B that includes an ion exchange stack 135B, an input manifold 136B-1, an output manifold 136B-2 and an electrolyte solution circulation system 139B. ED apparatus 130B may provide additional details regarding the multiple acid, salt and base chambers described above with reference to ED apparatus 130A (FIG. 2). That is, in some embodiments ED apparatus 130A (FIG. 3) is configured to include the features and details of ED apparatus 130B.

Ion exchange stack 135B includes multiple acid chambers 131B-1 to 131B-N, multiple salt chambers 132B-1 to 132B-N and multiple base chambers 133B-1 to 133B-N disposed in a repeating series of cells that are arranged in series between two end chambers 137B-1 and 137B-2. For example, a first cell in the series may include salt chamber 131B-1 disposed between associated acid chamber 132B-1 and associated base chamber 133B-1, and a last cell in the series may include salt chamber 131B-N disposed between associated acid chamber 132B-N and associated base chamber 133B-N. Each of the acid, salt and base chambers of ion exchange stack 135B may function as described above with reference to acid chamber 132, salt chamber 131 and base chamber 133, respectively, to process a corresponding portion of one of the acid, salt and base solution streams directed through ion exchange stack 134B by way of input manifold 136B-1 and output manifold 136B-2. That is, input manifold 136B-1 may split weak acid stream 112B-1 (which is received from an acid buffer tank (not shown) by way of acid inflow line 151B-2) such that corresponding portions of the acid stream pass through each acid chamber 131B-1 to 131B-N. Similarly, input manifold 136B-1 receives brine stream 111-1 by way of salt inflow line 151B-1 and splits brine stream 111-1 into multiple stream portions that are directed through salt chambers 131B-1 to 131B-N, and receives weak base stream 113B-1 from a base buffer tank (not shown) by way of base inflow line 151B-3 and splits weak base stream 113B-1 into multiple stream portions that are directed through base chambers 133B-1 to 133B-N. End chambers 137B-1 and 137B-2 may function to conduct an electrolyte solution indicated by “ES” for purposes described below.

Ion exchange stack 135B may include four types of ion permeable membranes that are respectively disposed between adjacent acid, salt, base and end chambers and facilitate the ion transfer process utilized to strengthen the base stream and the salt stream during operation of BPED 110B (i.e., when ion exchange stack 135B receives an electric field generated applying voltage potentials V+ and V− to anode 138B+ and cathode 138B−, respectively). The four types of membranes are indicated in FIG. 3 using the prefixes “A”, “K”, “B” and “F”, where membranes A1 to An are anion exchange membranes, membranes K1 to Kn are cation exchange membranes, membranes B1 to Bn are bipolar membranes, and membranes F1 and F2 are end membranes having characteristics described below. Electrolyte solution circulation system 139B may include a reservoir 139B-0 and flow lines 139B-1 to 139B-3 that function to circulate an electrolyte solution 114B through end chambers 137B-1 and 137B-2. That is, electrolyte solution 114B can be pumped from reservoir 139B-0 along first flow line 139B-1 to first end chamber 137B-1, from end chamber 137B-1 along second flow line 139B-2 to second end chamber 137B-2, and from second end chamber 137B-2 along third flow line 139B-3 to reservoir 139B-0. During operation the electrolyte solution may give up Na+ ions at one end of ion exchange stack 134B and reabsorbs Nat ions at the opposing end of ion exchange stack 135B. In some embodiments, electrolyte solution 114B is implemented using sodium sulfate or a semi conductive solution such as sodium hydroxide.

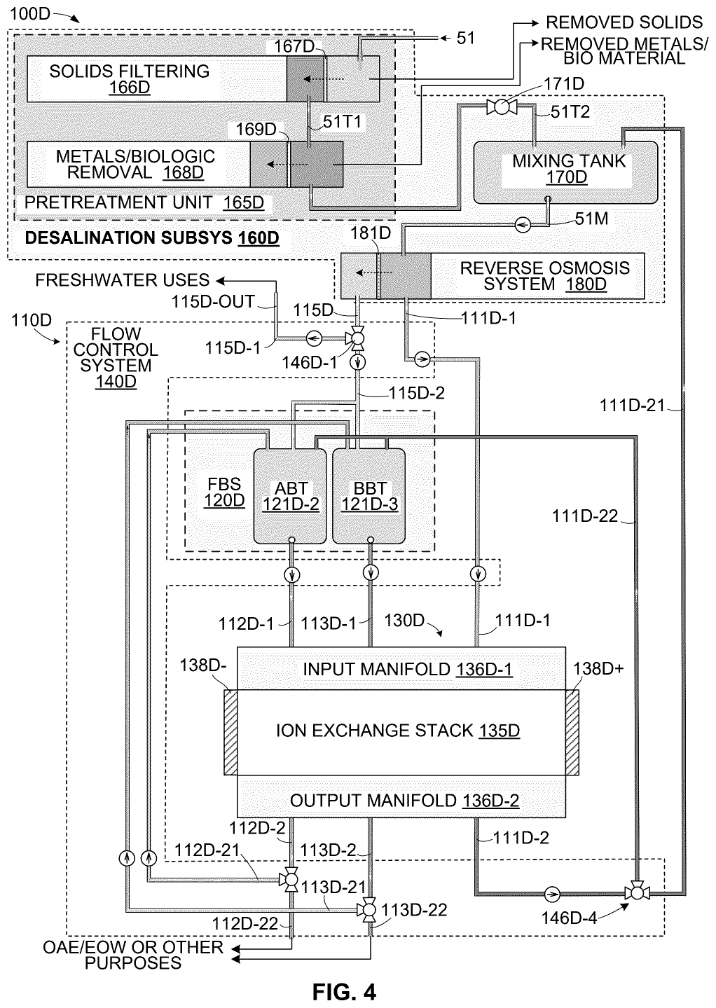

FIG. 4 shows a modified desalination system 100D including an electrochemical reactor 110D and a desalination subsystem 160D.

Referring to the lower portion of FIG. 4, electrochemical reactor 110D generally includes a fluid buffering system 120D, an ED apparatus 130D and a flow control system 140D. Fluid buffering system 120D includes an acid buffer tank (ABT) 121D-2 and a base buffer tank (BBT) 121D-3. Acid buffer tank 121D-2 stores an aqueous acid solution formed by a portion 112D-21 of an acid product stream 112D-2 exiting ED apparatus 130D and a portion 115D-21 of freshwater stream 115D exiting desalination subsystem 160D and supplies a relatively weak acid stream 112D-1 to ED apparatus 130D. Base buffer tank 121D-3 stores an aqueous base solution formed by a portion 113D-21 of a base product stream 113D-2 exiting ED apparatus 130D and a portion 115D-22 of freshwater stream 115D exiting desalination subsystem 160D and supplies a relatively weak base stream 113D-1 to ED apparatus 130D. ED apparatus 130D includes an ion exchange stack 135D disposed between electrodes 138D− and 138D+, an input manifold 136D-1 and an output manifold 136D-2, and is configured to receive and electrochemically process brine stream 111D-1, weak acid stream 112D-1 and weak base stream 113D-1 in the manner described above to generate reduced-salt stream 111D-2, acid product stream 112D-2 and base product stream 113D-2. Flow control system 140D includes pipes, pumps (indicated by circled arrows) and valves that are configured to direct the various solution flows between desalination subsystem 160D and electrochemical reactor 110D, and to selectively divert a portion 113D-22 of base product stream 113D-2 and a portion 112D-22 of acid product stream 112D-2 for one or more non-OAE purposes (e.g., for sale to a third party, or for system maintenance or commercial purposes). Flow control system 140D also includes flow control valves 146D-1 and 146D-4. Flow control valve 146D-1 effectively divides freshwater 115D exiting RO unit 180D into a first freshwater stream portion 115D-1 that is directed out of system 100D as freshwater output stream 115D-OUT and a second freshwater stream portion 115D-2 directed to fluid buffering system 120D. Flow control valve 146D-4 effectively divides reduced-salt stream 111D-2 into a first reduced-salt stream portion 111D-21 directed to desalination subsystem 160D and a second reduced-salt stream portion 111D-22 directed to fluid buffering system 120D. As discussed below, the system controller may utilize sensors and other control data to determine the flow amounts (flow rates) of each stream portion 111D-21, 111D-22, 115D-1 and 115D-2, and to adjust the operating states of flow control valves 146D-1 and 146D-4 by way of appropriate control signals to achieve the determined flow amounts.

Referring to the upper portion of FIG. 4, desalination subsystem 160D includes a pretreatment unit 165D, a mixing tank (mixing device) 170D and a reverse osmosis system (desalination unit) 180D.

Pretreatment unit 165D includes a solids filtering device 166D and a metals/biological removal device 168D that are connected in series such that raw saltwater feedstock 51 must pass through both series-connected filtering devices before being supplied to mixing tank 170D. Each filtering device 166D and 168D utilizes an associated filter to remove targeted contaminants from raw saltwater feedstock 51 (e.g., filtering system 166D utilizes one or more filters 167D that are optimize to remove solid particles from feedstock 51, and filtering system 168D utilizes one or more filters 169D that are optimized to remove metals and/or biologic materials from partially filtered seawater/brine 51T1 received from the first filtering system 166D). The order and number of filtering devices may be different from that shown in FIG. 4. As indicated by the arrows in the upper right portion of FIG. 4, the filtered contaminants (e.g. removed solids, metals and/or biological materials) are removed from the feedstock flow path using known techniques, and the resulting treated (filtered) feedstock solution 51T2 (i.e., the treated saltwater feedstock solution that has passed through both filters 167D and 169D) forms a treated saltwater feedstock stream 51T2 that is passed downstream to mixing tank 170D.

Mixing tank 170D is configured to receive reduced-salt stream portion 111D-21 (i.e., some or all of reduced-salt stream 111D-2 exiting ED apparatus 130D) and treated saltwater feedstock stream 51T2 from pretreatment unit 165D. Mixing tank 170D is also configured such that treated saltwater 51T and reduced-salt stream 111D-2 combine (intermix) within the mixing tank 165D to form saltwater/reduced-salt mixture 51M, which is then passed to RO system 180D. Mixing tank 170D is configured to generate mixture stream 51M by combining all of reduced-salt stream portion 111-21 received from electrochemical reactor 110 with a corresponding portion of treated/untreated saltwater feedstock 51T2, which may be controlled by way of a feedstock flow control device 171D in a manner similar to that described above with reference to FIG. 1.

RO system 180D receives mixtures stream 51M from mixing tank 170D and utilizes a semi-permeable membrane 181D that prevents the passage of salt molecules, whereby brine stream 111D-1 is formed on one side of membrane 181D and permeate (freshwater) passes through membrane 181D and exit as freshwater stream 115D. Similar to conventional desalination processes, freshwater stream 115D generated RO unit 180D has a suitably low salt concentration (e.g., ≤500 ppm), and brine stream 111-1 comprises an aqueous solution having salt content greater than 50,000 ppm (5%), whereby at least a portion of freshwater stream 115D is suitable for use as freshwater output stream 115D-OUT (i.e., suitable for human consumption and other freshwater uses).

Modified desalination system 100D also includes a system controller (not shown) that controls the various operations performed by electrochemical reactor 110D and desalination subsystem 160D way of operation/control signals in the manner described above. In addition, the system controller controls the operating states of flow control valves 146D-1 and 146D-4 in response to sensor data and/or externally supplied data to optimize system operations for reasons set forth above. In some embodiments, flow control valve 146D-4 may be controlled to stop all flow of reduced-salt solution to mixing device 170D, for example, when insufficient clean energy is available and/or electrochemical reactor 110D is shut down. During such periods system 100D may be operated in a manner similar to that implemented by a conventional desalination system.

FIG. 5 depicts a system 100E according to another embodiment. In the depicted embodiment, system 100E includes an OAE subsystem (electrochemical reactor) 110E, a seawater desalination subsystem 160E and an enhanced ocean weathering (EOW) subsystem 200, whereby system 100E is sometimes referred to herein as an integrated desalination/OAE/EOW system. However, in some embodiments EOW subsystem 200 may be omitted, whereby system 100E may be referred to as an integrated desalination/OAE system (i.e., by way of including OAE subsystem 110E and seawater desalination subsystem 160E). In other embodiments, seawater desalination subsystem 160E may be omitted (e.g., seawater 51 is pumped directly to OAE subsystem 110E), whereby system 100E may be referred to as a hybrid CDR system for reasons that will become clear below. Therefore, although system 100E is depicted as an integrated desalination/OAE/EOW system, it is understood that FIG. 5 also shows an integrated desalination/OAE system and a hybrid CDR system.

Referring to seawater desalination subsystem 160E (lower portion of FIG. 5), seawater 51 is pumped or otherwise drawn from ocean 50 into a pretreatment unit 165E (e.g., a nanofiltration, ultrafiltration, chemical precipitation or other water purification system) that is configured to treat (i.e., remove contaminants from) seawater 51. Treated seawater 51T is then mixed with reduced-salt stream 111E-22 in mixing device 170E to form a treated seawater/reduced-salt mixture solution 51M, and then mixture solution 51M is processed by a desalination unit 180E (e.g., a membrane-based or thermal desalination system) to generate freshwater 115E and a byproduct brine stream 111E-1, thereby providing freshwater output stream 115E. In one embodiment, pretreatment unit 165E is configured to remove hardness related minerals HRM (along with other contaminants) such that a hardness of seawater 51 is reduced before being supplied to mixing device 170E. In some embodiments, as indicated by the dashed-line arrow, the hardness related minerals HRM are supplied to a post-production unit 150E and returned to ocean 50 with the ocean alkalinity product and/or alkaline slurry (both discussed below).

OAE subsystem 110E includes a fluid buffering system 120E, an ED apparatus 130E and a flow control system that are configured and operate in the manner described in at least one of the previously described embodiments. ED apparatus 130E converts salt provided in brine stream 111E-1 into acid molecules (e.g., HCl) disposed in an acid product stream 112E-2 and base molecules (e.g., NaOH) disposed in a base product stream 113E-2. Base buffer tank 120E includes an acid buffer tank (ABT) that receives a (first) portion 112E-21 of acid product stream 112E-2 and supplies a weak acid stream to ED apparatus 130E, a base buffer tank (BBT) that receives a (first) portion 113E-21 of base product stream 113E-2 and supplies a weak base stream to ED apparatus 130E, and an optional salt buffer tank (SBT) that receives brine stream 111E-1 from desalination unit 180E and supplied brine stream 111E-1 to ED apparatus 130E. Although not depicted in FIG. 5 for clarity, portions of reduced salt stream 111E-2 and/or freshwater stream 115E may be directed to acid buffer tank (ABT) and base buffer tank (BBT) for the make-up and dilution purposes discussed above.

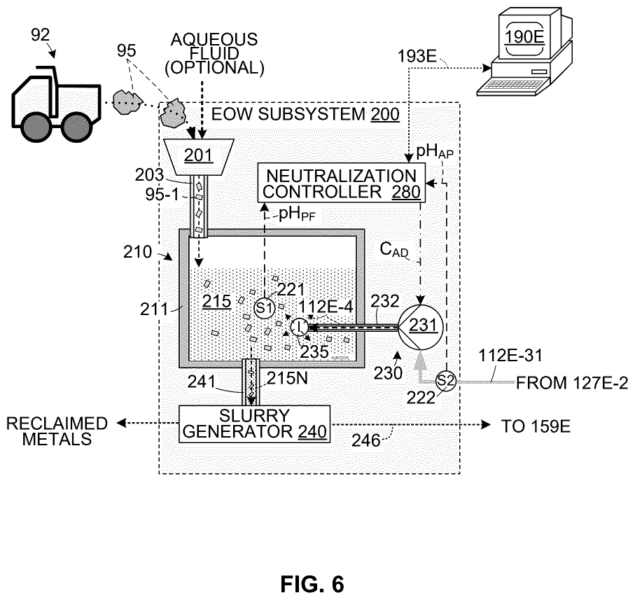

System 100E also includes a post-production unit 150E that selectively utilizes a portion 113E-22 of base product stream 113E-2 to generate an ocean alkalinity product 113E-OUT and selectively utilizes a portion 112E-22 of the acid product stream 112E-2 to generate an alkaline slurry 246, and then supplies (e.g., pumps) the ocean alkalinity product 113E-OUT and the alkaline slurry 246 to the ocean 50 at a designated outfall location 50-1 for OAE purposes (i.e., such that both the fully dissolved base substance in the ocean alkalinity product and the etched/weakened alkaline aggregate capture/reduce atmospheric carbon dioxide CO₂ and mitigate ocean acidification). In the exemplary embodiment, a portion of post-production unit 150E that is considered part of OAE subsystem 100E includes an acid product tank 127E-2, a base product tank 127E-3, an alkalinity product (ALK PROD) generator 153E and a base delivery subsystem 159E. Acid product tank 127E-2 receives and stores a portion 112E-22 of acid product stream 112E-2, and base product tank 127E-3 receives and stores a portion 113E-22 of base product stream 113E-2. Alkalinity product generation unit 153E is configured to generate an ocean alkalinity product 113E-OUT using a base product stream portion 113E-31, which is received from base product tank 127E-3, such that ocean alkalinity product 113E-OUT includes base molecules (NaOH) that are fully dissolved in a salt solution and has a pH level that is a predetermined amount higher than a pH level of the ocean's seawater 51 (e.g., in a target pH range between 8.0 and 9). In some embodiments, the ocean alkalinity product 113E-OUT is generated using a dilution apparatus configured to operate in the manner described in co-owned and co-pending U.S. Published Patent Application No. US 2024-0336503 A1, entitled “PRODUCTION EFFICIENCY OPTIMIZATION FOR BIPOLAR ELECTRODIALYSIS DEVICE”, which was published on Oct. 10, 2024, and is incorporated herein by reference in its entirety. Post-production unit 150E also includes an enhanced ocean weathering (EOW) subsystem 200 that is configured to generate an alkaline slurry 246 using an acid product stream portion 112E-31, which is received from acid product tank 127E-2, by combining acid product stream portion 112-31 with a coarsely-ground alkaline aggregate (rock) such that a reaction between the alkaline aggregate and the acid molecule both neutralizes the acid molecules and etches/weakens the alkaline aggregate. Enhanced ocean weathering subsystem 200 is described in additional detail below with reference to FIG. 6. Base delivery subsystem 159E is configured and controlled by system controller 190E to supply (e.g., pump) at least one of ocean alkalinity product 113E-OUT and alkaline slurry 246 to ocean 50 at a designated outfall location 50-1.

System controller 190E is programmed and otherwise configured to control operations of OAE subsystem 110E by way of control signals 191E, to control operations of desalination subsystem 160E by way of control signals 192E, and configured to control operations of post-production unit 150E by way of control signals 193E and 194E such that one or both of alkalinity product 113E-OUT and alkaline slurry 246 are selectively supplied to ocean 50 in safe and efficient manner. In one embodiment, system controller 190E monitors sensors and other data sources (e.g., via data 195E) and controls base delivery system 159E by way of control signal 194E such that ocean alkalinity product 113E-OUT and alkaline slurry 246 are only supplied to ocean 50 when data 195E indicates that sea life adjacent to outfall location 50-1 will not be endangered by the release of these OAE substances. In another embodiment, system controller 190E may monitor one or more sites that provide input data 195E including spot pricing for the base product and/or acid product generated by electrochemical reactor 110E. Controller 190E may then utilize this input data to determine whether the base and/or acid products should be utilized for OAE/EOW purposes, or whether they should be sold to a third-party buyer. For example, when sufficient low/zero-carbon electricity is available from a power grid to offset the desalination process carbon footprint and the base product spot price is sufficiently high, then the controller 190E may direct the post-production unit 150E (e.g., by way of control signals 191E) to divert a base product portion 113E-220 (e.g., some or all of the second base stream portion 113E-22) for sale to a third-party buyer (i.e., instead of directing the base product to ocean 50 as part of ocean alkalinity product 113E-OUT), whereby proceeds from the sale serve to reduce total operating costs of system 100E. Similarly, the control algorithm implemented by system controller 190E may monitor input data 195E from one or more sites that provide spot pricing for the acid product (e.g., HCl), and utilizes this data to determine whether it is more cost effective to neutralize the acid product (e.g., by way of EOW subsystem 200), or if selling the acid product may produce a greater value (i.e., if the acid product spot price is sufficiently high), in which case the controller 190E may direct the post-production unit 150E to divert an acid product portion 112E-220 (e.g., some or all of the second acid stream portion 112E-22) for sale to a third-party buyer.

FIG. 6 shows EOW subsystem 200 of integrated desalination/OAE/EOW system 100E (see FIG. 5) according to an exemplary embodiment. EOW subsystem 200 includes an accelerated ocean weathering reaction apparatus 210, a dosing apparatus 230, a slurry generator 240 and a neutralization controller 280. Accelerated ocean weathering reaction apparatus 210 includes a reaction tank 211 configured to contain a process fluid 215 including a mixture of alkaline aggregate 95 and acid product portion 112E-31 until the acid molecules are neutralized and alkaline aggregate 95 is etched/weakened. In some embodiments, alkaline aggregate 95 may be transported from a quarry or other source by a material delivery vehicle 92 and processed by an optional pre-crusher/grinder 201 before the pre-crushed/ground alkaline aggregate 95-1 is delivered into reaction tank 211 by way of an inlet pipe 203. Dosing apparatus includes one or more dosing pumps 231 that receive acid product portion 112E-31 from acid product tank 127E-2 and is controlled by neutralization controller 280 to inject acid product doses 112E-4 into reaction tank 211 by way of an injector 235. Neutralization controller 280 controls the delivery/injection of alkaline aggregate and acid product into reaction tank 211 by way of monitoring a process fluid pH measurement data pH_{PF} generated by a first sensor S1 disposed inside reaction tank 211 and acid product pH measurement data pH_{AP} generated by a second sensor S2 disposed upstream from acid dosing pump(s) 231. During operation neutralization controller 280 controls the injection rate of acid product doses 112E-4 into reaction tank 211 such that a pH level of process fluid 215 is optimized such that acid molecules are neutralized and alkaline aggregate 95 is etched/weakened at a maximum rate. Neutralized product (i.e., a combination of neutralized acid solution and weakened/etched alkaline aggregate) is passed from reaction tank 211 to slurry generator 240 by way of an outlet pipe 241. Slurry generator 240 is configured to generate alkaline slurry 246 by processing (e.g., crushing/grinding) the etched/weakened alkaline aggregate of neutralized product 215N into fine particles, and then passes alkaline slurry 246 to base delivery subsystem 159E (see FIG. 5). In some embodiments, the accelerated weathering reaction causes the release of one or more metal elements (e.g., Nickel, Cobalt, Aluminum, Magnesium, Potassium and/or Lithium) from the alkaline aggregate and the slurry generator 240 is configured reclaim (i.e., separate and remove) the released metal elements from alkaline slurry 246 using known techniques, whereby system costs may be further reduced/offset by way of commercial sale of the reclaimed metals. In some embodiments, the operation of EOW subsystem 200 is controlled by system controller 190E by way of control signals 193E passed to neutralization controller 280.

Referring again to FIG. 5, by configuring post-production unit 150E to implement both alkaline production generator 153E and EOW subsystem 200, system 100E implements a hybrid carbon dioxide removal (CDR) process and a reduced ocean acidification (ROA) process that combines some portions of each of a conventional electrochemical ocean alkalinity enhancement (EOAE) process and a conventional EOW process to achieve combined beneficial results (i.e., CDR/ROA-EOAE and CDR/ROA-EOW) achieved by both conventional processes, but changes other portions of each conventional processes in a way that reduces total operating costs (i.e., in comparison to separately performing the two conventional processes). For example, in one embodiment the hybrid CDR system implements the conventional EOAE process portions related to electrochemically processing salt to generate a base substance (e.g., NaOH) and an acid substance (e.g., HCl) and supplying the base substance to the ocean by way of an ocean alkalinity product, and the hybrid CDR system also implements the conventional EOW process portion related to mining and transporting alkaline aggregate/rock. The changes to the conventional EOAE and EOW processes occur after the acid byproduct is produced and after the alkaline rock is transported, whereby the conventional disposal of the acid byproduct and conventional crushing/grinding of the alkaline rock are replaced with an advanced weathering operation that includes combining alkaline rock and the acid product/substance generated by ED apparatus 130. In the embodiment described above with reference to FIG. 6, the advanced weathering operation involves mixing the acid product portion 112E-31 and alkaline rock/aggregate (e.g., olivine/basalt or other mafics/ultramafics) to produce alkaline slurry 246 with a pH between two and eight. As discussed above, slurry generation may include pre-grinding/crushing and/or post-reaction processing of the alkaline rock, but these optional processes require substantially less externally supplied energy than that required by the conventional crushing/grinding process and therefore costs less to perform than conventional acid disposal and crushing/grinding. During the advanced weathering operation, the acid substance in the acid byproduct reacts with alkaline substances in the alkaline rock, thereby weakening and/or increasing the surface area of the alkaline rock and neutralizing the acid substance. During the advanced weathering operation valuable and/or toxic metal constituents of the alkaline aggregate (Ni, Co, Al, Mg, K, Li, etc.) may be reclaimed from the slurry using known techniques. The advanced weathering process proceeds until the acid substance (e.g., HCl) supplied in the acid byproduct is neutralized, at which point the final alkaline slurry has a pH higher than ambient ocean pH (>7.5). The final alkaline slurry could then be dispersed into the ocean via fixed point (e.g., by way of base delivery subsystem 159E) or released from a moving vessel.

Although the invention is primarily described herein in the context of seawater desalination and seawater-based OAE systems/methods, various novel aspects described herein may be beneficially utilized in other systems/methods without departing from the spirit and scope of the invention. For example, the chemical reactor implemented by the present invention may be utilized to electrochemically process a wide variety of salt types to generate corresponding base and acid substances. It will be clear to those skilled in the art that the inventive features of the present invention are applicable to these other embodiments as well, and that all of which are intended to fall within the scope of the present invention.

1. A desalination system for generating a freshwater stream by removing salt from a saltwater feedstock having a first salt concentration level such that the removed salt is concentrated in a brine stream having a second salt concentration level, the second salt concentration level being higher than the first concentration level, the desalination system comprising:
an electrochemical reactor configured to generate a reduced-salt stream by electrochemically processing the brine stream such that the salt contained in the brine stream is converted into acid molecules contained in an acid product stream and base molecules contained in a base product stream, and such that the reduced-salt stream exiting the electrochemical reactor has a third salt concentration that is lower than the first salt concentration;
a mixing device configured to combine a saltwater feedstock stream including the saltwater feedstock with at least some of the reduced-salt stream to produce a mixture stream having a fourth salt concentration that is between the first and third salt concentrations; and
a desalination unit configured to generate the freshwater stream and the brine stream by processing the mixture stream.

2. The system of claim 1, further comprising a pretreatment unit configured to generate the saltwater feedstock stream by removing contaminants from a portion of the saltwater feedstock received from an external source.

3. The system of claim 2, wherein the mixing device is configured such that the mixture stream includes all of the reduced-salt stream received from the electrochemical reactor and such that the mixture stream exiting the mixing device is maintained at a constant outflow rate by adjusting an inflow rate of the saltwater feedstock stream entering the mixing device.

4. The system of claim 1, wherein the desalination unit comprises one of a thermal desalination system and a membrane-based desalination system.

5. The system of claim 1, wherein the electrochemical reactor comprises:
an electrodialysis (ED) apparatus including an ion exchange stack comprising a plurality of chambers arranged in series between opposing electrodes and respectively separated by intervening ion exchange membranes; and
a flow control system configured to direct the brine stream to a first chamber of the plurality of chambers and to direct the reduced-salt stream from said first chamber, to direct an aqueous acid solution to a second chamber of the plurality of chambers and to direct said acid product stream away from said second chamber, and to direct an aqueous base solution to a third chamber of the plurality of chambers and to direct said base product stream away from said third chamber,
wherein the ED apparatus is configured such that chloride ions disposed in the brine stream pass from the first chamber through a first ion exchange membrane into the second chamber, and such that sodium ions disposed in the brine stream pass from the first chamber through a second ion exchange membrane into the third chamber.

6. The system of claim 5, wherein the electrochemical reactor further comprises a fluid buffering system including:
an acid buffer tank configured to contain the aqueous acid solution directed into said second chamber of the ED apparatus and to receive a first portion of the acid product stream directed away from said second chamber of the ED apparatus; and
a base buffer tank configured to contain the aqueous base solution directed into said third chamber of the ED apparatus and to receive a first portion of the base product stream directed away from said third chamber of the ED apparatus,
wherein the flow control system is further configured to direct a portion of the generated freshwater into one or more of said acid buffer tank and said base buffer tank.

7. The system of claim 1,
wherein the saltwater feedstock comprises raw seawater obtained from an ocean,
wherein the system further comprises a post-production unit including at least one of:
an alkalinity product generation unit configured to generate an ocean alkalinity product using at least a portion of the base product stream such that the ocean alkalinity product includes said base molecules fully dissolved in a salt solution and has a pH level that is a predetermined amount higher than a pH level of the ocean's seawater;
an enhanced ocean weathering subsystem configured to generate an alkaline slurry using at least a portion of the acid product stream by combining the acid product stream portion with an alkaline aggregate such that a reaction between the alkaline aggregate and the acid molecules both neutralizes the acid molecules and etches the alkaline aggregate; and
a base delivery system configured to supply at least one of the ocean alkalinity product and the alkaline slurry to the ocean at a designated outfall location.

8. A method for generating a freshwater stream by removing salt from a saltwater feedstock having a first salt concentration level such that the removed salt is concentrated in a brine stream having a second salt concentration level, the second salt concentration level being higher than the first concentration level, the method comprising:
generating a reduced-salt stream by electrochemically processing the brine stream such that at least some of the salt contained in the brine stream is converted into acid molecules contained in an acid product stream and base molecules contained in a base product stream, and such that the reduced-salt stream has a third salt concentration that is lower than the first salt concentration;
generating a mixture stream having a fourth salt concentration that is between the first and third salt concentrations by combining a saltwater feedstock stream including the saltwater feedstock with the reduced-salt stream; and
desalinating the mixture stream to generate the freshwater stream and the brine stream.

9. The method of claim 8, further comprising generating the saltwater feedstock stream by removing contaminants from a portion of the saltwater feedstock received from an external source.

10. The method of claim 9, wherein generating the mixture stream comprises utilizing all of the reduced-salt stream received from the electrochemical reactor and maintaining the mixture stream at a constant outflow rate by adjusting an inflow rate of the saltwater feedstock stream.

11. The method of claim 8, wherein desalinating the mixture stream comprises utilizing one of a thermal desalination system and a membrane-based desalination system.

12. The method of claim 8, wherein generating a reduced-salt stream comprises:
directing the brine stream through a first chamber while directing an aqueous acid solution to a second chamber and directing an aqueous base solution to a third chamber, the first chamber being disposed between the second chamber and the third chamber;
applying an electric field across the first, second and third chambers such that chloride ions disposed in the brine stream pass from the first chamber through a first ion exchange membrane into the second chamber, and such that sodium ions disposed in the brine stream pass from the first chamber through a second ion exchange membrane into the third chamber.

13. The method of claim 12, further comprising:
directing the aqueous acid solution from an acid buffer tank into said second chamber and directing a first portion of the acid product stream exiting the second chamber to the acid buffer tank;
directing the aqueous base solution from a base buffer tank into said third chamber and directing a first portion of the base product stream exiting the third chamber to the base buffer tank; and
directing a portion of the generated freshwater into one or more of said acid buffer tank and said base buffer tank.

14. The method of claim 8,
wherein the saltwater feedstock comprises raw seawater obtained from an ocean, and
wherein the method further comprises:
generating an ocean alkalinity product using at least a portion of the base product stream such that the ocean alkalinity product includes said base molecules fully dissolved in a salt solution and has a pH level that is a predetermined amount higher than a pH level of the ocean's seawater; and
supplying the ocean alkalinity product to the ocean at a designated outfall location.

15. The method of claim 8,
wherein the saltwater feedstock comprises raw seawater obtained from an ocean, and
wherein the method further comprises:
generating an alkaline slurry by combining at least a portion of the base product stream with analkaline aggregate such that a reaction between the alkaline aggregate and the acid molecules both neutralizes the acid molecules and etches the alkaline aggregate; and
supplying the alkaline slurry to the ocean at a designated outfall location.

16. A hybrid carbon dioxide removal (CDR) system comprising:
an ocean alkalinity enhancement (OAE) subsystem including an electrodialysis device configured to electrochemically process salt obtained from an ocean's seawater such that the salt is converted into a base substance and an acid substance, the OAE subsystem further including an alkaline product generator configured to generate an ocean alkalinity product including the base substance fully dissolved in a salt solution;
an enhanced ocean weathering (EOW) subsystem configured to generate an alkaline slurry by combining a portion of the acid substance from the electrodialysis device with an alkaline aggregate such that an accelerated ocean weathering reaction between the alkaline aggregate and the acid substance both neutralizes the acid substance and etches/weakens the alkaline aggregate; and
a base delivery subsystem configured to supply the ocean alkalinity product and the alkaline slurry to an ocean such that both the fully dissolved base substance and the etched/weakened alkaline aggregate capture/reduce atmospheric carbon dioxide and mitigate ocean acidification.

17. The hybrid CDR system of claim 16, wherein the EOW subsystem comprises:
an accelerated ocean weathering reaction apparatus includes a reaction tank configured to contain a process fluid including a mixture of the alkaline aggregate and acid substance portion until the accelerated ocean weathering reaction is completed; and
a slurry generator configured to generate the alkaline slurry by processing the etched/weakened alkaline aggregate contained in the process fluid received from the accelerated ocean weathering reaction apparatus.

18. The hybrid CDR system of claim 17, wherein the slurry generator further is further configured to separate (reclaim) one or more metal elements from the alkaline slurry.

19. The hybrid CDR system of claim 16, further comprising:
a mixing device configured to combine a saltwater feedstock stream including the ocean's seawater with the base substance exiting the electrodialysis device to produce a mixture stream; and
a desalination unit configured to generate a freshwater stream and a brine stream by processing the mixture stream.

20. The hybrid CDR system of claim 19, wherein electrodialysis device is configured to receive and electrochemically process salt contained in the brine stream.
